(19) United States
(12) Patent Application Publication
(10) Pub. No.: US 2010/0220178 A1
(43) Pub. Date: Sep. 2, 2010

(54) IMAGE PROCESSING APPARATUS, IMAGE PROCESSING METHOD, PROGRAM, AND THREE-DIMENSIONAL IMAGE DISPLAY APPARATUS

(76) Inventors: Shuichi TAKAHASHI, Kanagawa (JP); Isao Ohashi, Kanagawa (JP); Takuya Ooi, Tokyo (JP)

Correspondence Address: FROMMER LAWRENCE & HAUG LLP, 745 FIFTH AVENUE, NEW YORK, NY, 10151, US

(21) Appl. No.: 12/708,707

(22) Filed: Feb. 19, 2010

(30) Foreign Application Priority Data
Feb. 27, 2009 (JP) P2009-045284

(51) Int. Cl. H04N 13/04

(52) U.S. Cl. 348/54; 348/E13.075

(57) ABSTRACT

An image processing apparatus includes: an adjustment amount setting section to set an adjustment amount of a parallax amount with respect to a two-dimensional image for left eye and a two-dimensional image for right eye; a difference calculation section to calculate a difference between brightness values of the two-dimensional image for left eye and the two-dimensional image for right eye in which the parallax amount is changed using the adjustment amount set by the adjustment amount setting section; a smallest value judgment section to determine an optimum adjustment amount by judging the adjustment amount at which a calculation amount using the difference between brightness values is smallest; and a parallax amount adjustment section to adjust the parallax amount of the two-dimensional image for left eye and the two-dimensional image for right eye, based on the optimum adjustment amount determined by the smallest value judgment section.

### BACKGROUND OF THE INVENTION

1. Field of the Invention

The present invention relates to an image processing apparatus, an image processing method, a program, and a three-dimensional image display apparatus, and more particularly, to an image processing apparatus, an image processing method, a program, and a three-dimensional image display apparatus that are capable of displaying a three-dimensional image in which crosstalk is reduced more.

2. Description of the Related Art

In recent years, studies on display of three-dimensional images have been actively made. As methods of presenting a three-dimensional image to a viewer, there is a method of presenting different two-dimensional images to a human left eye and right eye and causing the eyes to perceive a three-dimensional image due to parallax of those two two-dimensional images, for example. By perceiving depth in accordance with the parallax provided to the two-dimensional image for left eye and the two-dimensional image for right eye, the viewer can recognize the viewing images as a three-dimensional image.

It should be noted that in addition to the format in which the two-dimensional image for left eye and its corresponding two-dimensional image for right eye are held as a set, three-dimensional image data is also held in a format in which two-dimensional images and depth information thereof are held as a set. Also in the case where the three-dimensional image data is held in the format in which two-dimensional images and depth information thereof are held as a set, a two-dimensional image for left eye and a two-dimensional image for right eye are generated from the two-dimensional images and the depth information. Accordingly, the way to present an image to a viewer is the same as in the case of the two-dimensional image for left eye and two-dimensional image for right eye described above.

In such a method of presenting the different two-dimensional images to the human left eye and right eye, means for separating the two-dimensional image for left eye and the two-dimensional image for right eye from each other is needed. As the means for separating the two-dimensional image for left eye and the two-dimensional image for right eye from each other, for example, there is a method of wearing glasses having polarization properties that are different on the left eye side and the right eye side. Further, methods of viewing images with the naked eyes without using glasses include a method of attaching a lens sheet onto a display and adjusting an optical path so that different images are entered to the left eye and the right eye of a viewer being at a predetermined position.

In the method of presenting different two-dimensional images to a human left eye and right eye and causing the eyes to perceive a three-dimensional image, there arises a problem how appropriately an amount of parallax of the two-dimensional image for left eye and the two-dimensional image for right eye (parallax amount) is set.

Examples of a technique of adjusting the parallax amount of the two-dimensional image for left eye and the two-dimensional image for right eye include a technique proposed in Japanese Patent No. 3,749,227 (hereinafter, referred to as Patent Document 1), for example.

Patent Document 1 discloses a method of presenting a plurality of two-dimensional images for left eye and two-dimensional images for right eye having different parallax amounts to a viewer and adjusting the parallax amounts by the viewer answering whether the presented image is acceptable. Accordingly, it is possible to make an adjustment to a parallax amount that the viewer feels favorable. In addition, it is possible to store the parallax amount adjusted once and also display different images with the same parallax amount.

### SUMMARY OF THE INVENTION

In the method of adjusting the parallax amount, which is disclosed in Patent Document 1, it is assumed that the two-dimensional image for left eye and the two-dimensional image for right eye can be completely separated from each other and viewed.

However, a phenomenon in which a two-dimensional image for one eye is unintentionally incident on the other eye, that is, crosstalk, is caused more than a little. In a method of using a polarization filter, for example, crosstalk of about 5% is caused. In other words, a 5% portion of the two-dimensional image for left eye is superimposed on the two-dimensional image for right eye, and a 5% portion of the two-dimensional image for right eye is superimposed on the two-dimensional image for left eye.

Therefore, in the method of adjusting a parallax amount, disclosed in Patent Document 1, it is highly possible that even in the image with a parallax amount that the viewer feels favorable, the parallax amount has been adjusted in a state where crosstalk is caused.

In the case where crosstalk is caused, pixels of the two-dimensional image for left eye and those of the two-dimensional image for right eye that are completely match are not affected, whereas those that do not match are viewed as a double image. As a result, the image is difficult to be perceived as a three-dimensional image and additionally the viewer may suffer a physiological response such as headache.

In view of the circumstances as described above, it is desirable to display a three-dimensional image in which crosstalk is reduced more.

According to an embodiment of the present invention, there is provided an image processing apparatus including: an adjustment amount setting means for setting an adjustment amount of a parallax amount with respect to a two-dimensional image for left eye and a two-dimensional image for right eye; a difference calculation means for calculating a difference between brightness values of the two-dimensional image for left eye and the two-dimensional image for right eye in which the parallax amount is changed using the adjustment amount set by the adjustment amount setting means; a smallest value judgment means for determining an optimum adjustment amount by judging the adjustment amount at which a calculation amount using the difference between brightness values is smallest; and a parallax amount adjustment means for adjusting the parallax amount of the two-dimensional image for left eye and the two-dimensional image for right eye, based on the optimum adjustment amount determined by the smallest value judgment means.

According to another embodiment of the present invention, there is provided an image processing method including: setting an adjustment amount of a parallax amount with respect to a two-dimensional image for left eye and a two-dimensional image for right eye; calculating a difference between brightness values of the two-dimensional image for left eye and the two-dimensional image for right eye in which the parallax amount is changed using the set adjustment amount; determining an optimum adjustment amount by judging the adjustment amount at which a calculation amount using the difference between brightness values is smallest; and adjusting the parallax amount of the two-dimensional image for left eye and the two-dimensional image for right eye, based on the determined optimum adjustment amount.

According to another embodiment of the present invention, there is provided a program causing a computer to execute: setting an adjustment amount of a parallax amount with respect to a two-dimensional image for left eye and a two-dimensional image for right eye; calculating a difference between brightness values of the two-dimensional image for left eye and the two-dimensional image for right eye in which the parallax amount is changed using the set adjustment amount; determining an optimum adjustment amount by judging the adjustment amount at which a calculation amount using the difference between brightness values is smallest; and adjusting the parallax amount of the two-dimensional image for left eye and the two-dimensional image for right eye, based on the determined optimum adjustment amount.

In the above embodiments of the present invention, the adjustment amount of the parallax amount is set with respect to the two-dimensional image for left eye and the two-dimensional image for right eye, the difference between brightness values of the two-dimensional image for left eye and the two-dimensional image for right eye in which the parallax amount is changed using the set adjustment amount is calculated, the optimum adjustment amount is determined by judging the adjustment amount at which the calculation amount using the difference between brightness values is smallest, and the parallax amount of the two-dimensional image for left eye and the two-dimensional image for right eye is adjusted based on the determined optimum adjustment amount.

According to another embodiment of the present invention, there is provided a three-dimensional image display apparatus including: an adjustment amount setting means for setting an adjustment amount of a parallax amount with respect to a two-dimensional image for left eye and a two-dimensional image for right eye; a difference calculation means for calculating a difference between brightness values of the two-dimensional image for left eye and the two-dimensional image for right eye in which the parallax amount is changed using the adjustment amount set by the adjustment amount setting means; a smallest value judgment means for determining an optimum adjustment amount by judging the adjustment amount at which a calculation amount using the difference between brightness values is smallest; a parallax amount adjustment means for adjusting the parallax amount of the two-dimensional image for left eye and the two-dimensional image for right eye, based on the optimum adjustment amount determined by the smallest value judgment means; and a display means for displaying the two-dimensional image for left eye and the two-dimensional image for right eye in which the parallax amount is adjusted by the parallax amount adjustment means.

In the above embodiment of the present invention, the adjustment amount of the parallax amount is set with respect to the two-dimensional image for left eye and the two-dimensional image for right eye, the difference between brightness values of the two-dimensional image for left eye and the two-dimensional image for right eye in which the parallax amount is changed using the set adjustment amount is calculated, the optimum adjustment amount is determined by judging the adjustment amount at which the calculation amount using the difference between brightness values is smallest, the parallax amount of the two-dimensional image for left eye and the two-dimensional image for right eye is adjusted based on the determined optimum adjustment amount, and the two-dimensional image for left eye and the two-dimensional image for right eye in which the parallax amount is adjusted are displayed. Accordingly, a three-dimensional image can be viewed.

According to another embodiment of the present invention, there is provided an image processing apparatus including: an adjustment amount setting section to set an adjustment amount of a parallax amount with respect to a two-dimensional image for left eye and a two-dimensional image for right eye; a difference calculation section to calculate a difference between brightness values of the two-dimensional image for left eye and the two-dimensional image for right eye in which the parallax amount is changed using the adjustment amount set by the adjustment amount setting section; a smallest value judgment section to determine an optimum adjustment amount by judging the adjustment amount at which a calculation amount using the difference between brightness values is smallest; and a parallax amount adjustment section to adjust the parallax amount of the two-dimensional image for left eye and the two-dimensional image for right eye, based on the optimum adjustment amount determined by the smallest value judgment section.

According to another embodiment of the present invention, there is provided a three-dimensional image display apparatus including: an adjustment amount setting section to set an adjustment amount of a parallax amount with respect to a two-dimensional image for left eye and a two-dimensional image for right eye; a difference calculation section to calculate a difference between brightness values of the two-dimensional image for left eye and the two-dimensional image for right eye in which the parallax amount is changed using the adjustment amount set by the adjustment amount setting section; a smallest value judgment section to determine an optimum adjustment amount by judging the adjustment amount at which a calculation amount using the difference between brightness values is smallest; a parallax amount adjustment section to adjust the parallax amount of the two-dimensional image for left eye and the two-dimensional image for right eye, based on the optimum adjustment amount determined by the smallest value judgment section; and a display section to display the two-dimensional image for left eye and the two-dimensional image for right eye in which the parallax amount is adjusted by the parallax amount adjustment section.

It should be noted that it is possible to provide the program by being transmitted via a transmission medium or recorded in a recording medium.

The image processing apparatus may be an independent apparatus or may be an internal block constituting one apparatus.

According to the embodiments of the present invention, it is possible to display a three-dimensional image in which crosstalk is reduced more.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 are diagrams showing a two-dimensional image for left eye and a two-dimensional image for right eye that are used for displaying a three-dimensional image;

FIG. 2 is a diagram showing a three-dimensional image without crosstalk;

FIG. 3 is a diagram showing an image at a time when crosstalk is caused;

FIG. 4 is a diagram showing an example of results of first parallax amount adjustment processing performed by an image processing apparatus according to an embodiment of the present invention;

FIG. 5 is a diagram showing an example of results of second parallax amount adjustment processing performed by an image processing apparatus according to an embodiment of the present invention;

FIG. 6 is a block diagram showing a structural example of an image processing apparatus according to a first embodiment of the present invention;

FIG. 7 is a flowchart for explaining the first parallax amount adjustment processing;

FIG. 8 is a block diagram showing a structural example of an image processing apparatus according to a second embodiment of the present invention;

FIG. 9 is a flowchart for explaining the second parallax amount adjustment processing;

FIG. 10 are diagrams showing an example of brightness values of pixels of the two-dimensional image for left eye and the two-dimensional image for right eye;

FIG. 11 is a diagram showing differences between the brightness values of the pixels in FIG. 10;

FIG. 12 is a diagram showing differences between the brightness values of the pixels at a time when an adjustment amount is set to “−2”;

FIG. 13 is a diagram showing differences between the brightness values of the pixels at a time when the adjustment amount is set to “−1”;

FIG. 14 is a diagram showing differences between the brightness values of the pixels at a time when the adjustment amount is set to “+1”;

FIG. 15 is a diagram showing differences between the brightness values of the pixels at a time when the adjustment amount is set to “+2”;

FIG. 16 is a block diagram showing a structural example of an image processing apparatus according to a third embodiment of the present invention;

FIG. 17 is a block diagram showing a structural example of an image processing apparatus according to a fourth embodiment of the present invention;

FIG. 18 is a block diagram showing a structural example of an image processing apparatus according to a fifth embodiment of the present invention;

FIG. 19 is a flowchart for explaining the first parallax amount adjustment processing performed after region division has been made;

FIG. 20 is a flowchart for explaining the second parallax amount adjustment processing performed after the region division has been made;

FIG. 21 is a diagram showing an example of divided regions;

FIG. 22 are diagrams showing the two-dimensional image for left eye and the two-dimensional image for right eye of FIG. 10 in which the region division has been made;

FIG. 23 is a diagram showing the differences between the brightness values of FIG. 10 in which the region division has been made;

FIG. 24 is a diagram showing the differences between the brightness values of FIG. 11 in which the region division has been made;

FIG. 25 is a diagram showing the differences between the brightness values of FIG. 12 in which the region division has been made;

FIG. 26 is a diagram showing the differences between the brightness values of FIG. 13 in which the region division has been made;

FIG. 27 is a diagram showing the differences between the brightness values of FIG. 14 in which the region division has been made;

FIG. 28 is a diagram showing the differences between the brightness values of FIG. 15 in which the region division has been made;

FIG. 29 is a block diagram showing a structural example of an image processing apparatus according to a seventh embodiment of the present invention;

FIG. 30 is a block diagram showing a structural example of a three-dimensional image display apparatus according to an embodiment of the present invention; and

FIG. 31 is a block diagram showing a structural example of a computer according to an embodiment of the present invention.

### DESCRIPTION OF PREFERRED EMBODIMENTS

### Description on Concept of the Present Invention

First, a concept of processing performed by image processing apparatuses according to embodiments of the present invention will be described.

Each of the image processing apparatuses according to the embodiments of the present invention is a parallax amount adjustment apparatus that adjusts a parallax amount provided to a two-dimensional image for left eye and a two-dimensional image for right eye that are recognized as a three-dimensional image by a viewer.

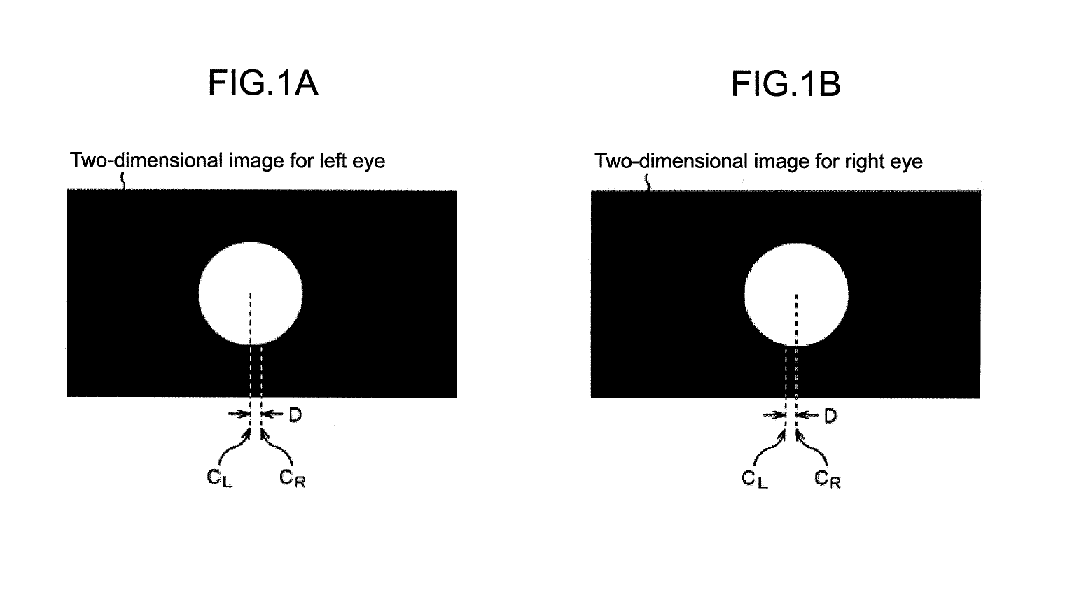

FIG. 1 show an example of the two-dimensional image for left eye and the two-dimensional image for right eye.

FIG. 1A shows the two-dimensional image for left eye, and FIG. 1B shows the two-dimensional image for right eye.

In FIG. 1, it is assumed that each hollow circle in the two-dimensional image for left eye and the two-dimensional image for right eye is a predetermined object. A center position C_{L} of the object of the two-dimensional image for left eye is arranged on a left-hand side of a center position C_{R} of the object of the two-dimensional image for right eye. In the other way around, the center position C_{R} of the object of the two-dimensional image for right eye is arranged on a right-hand side of the center position C_{L} of the object of the two-dimensional image for left eye. The center position C_{L} of the object of the two-dimensional image for left eye and the center position C_{R} of the object of the two-dimensional image for right eye are different by a distance D. The distance D is approximately proportional to a parallax amount. Accordingly, the distance D is hereinafter redefined as a parallax amount and used.

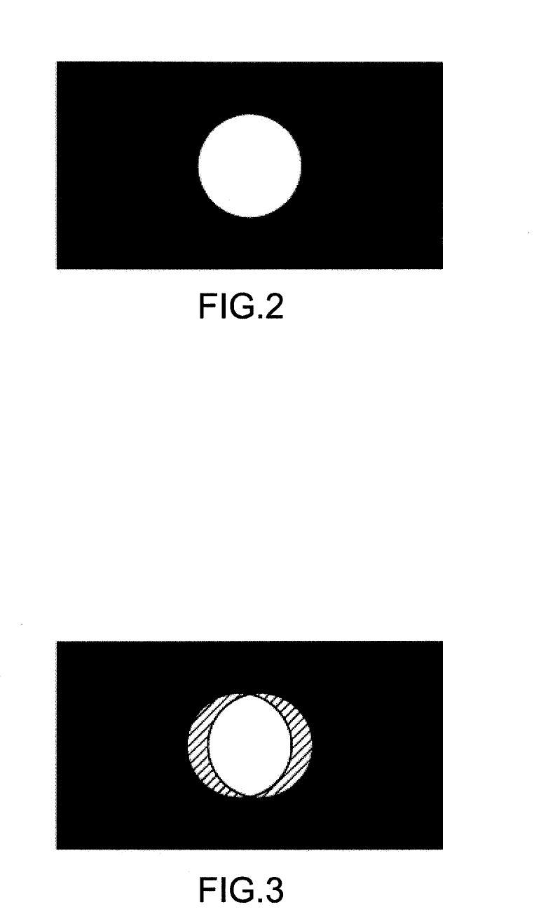

In a case where the parallax amount D of the two-dimensional image for left eye and the two-dimensional image for right eye is sufficiently small with respect to a distance between a display surface of a display apparatus on which the two-dimensional image for left eye and the two-dimensional image for right eye are displayed and a viewer, the objects become one when viewed with both the eyes and are perceived on a deep side of a screen (three-dimensionally viewed) as shown in FIG. 2.

On the other hand, for example, in a case where the parallax amount D is large, shaded portions shown in FIG. 3 may be perceived as crosstalk by a target eye and an opposite eye. As a result, both the two-dimensional image for left eye and the two-dimensional image for right eye are viewed by both the eyes and are hindered from being three-dimensionally viewed. That is, the viewer visually recognizes that the objects are not drawn to the deep side of the screen but two circles are attached to the screen. Accordingly, in order for the viewer to visually recognize that an image is appropriately popped up or drawn, it is necessary to suppress the crosstalk.

The crosstalk is caused in an area shown as the shaded portions of FIG. 3, in which brightness values of pixels of the two-dimensional image for left eye and those of the two-dimensional image for right eye are largely different from each other. Accordingly, in a case where differences between the brightness values of pixels of the two-dimensional image for left eye and those of the two-dimensional image for right eye are small as a whole, the crosstalk can be suppressed more.

In this regard, the image processing apparatus according to each embodiment of the present invention adjusts a parallax amount by the following first and second parallax amount adjustment processing. As the first parallax amount adjustment processing, the image processing apparatus sets, as an optimum parallax amount, a parallax amount at which a sum of differences between brightness values of pixels of the two-dimensional image for left eye and those of the two-dimensional image for right eye in the entire image becomes smallest. Further, as the second parallax amount adjustment processing, the image processing apparatus sets, as an optimum parallax amount, a parallax amount at which the number of pixels having a difference equal to or larger than a predetermined threshold value TH becomes smallest while disregarding slight differences between the brightness values on the assumption that they are not perceivable.

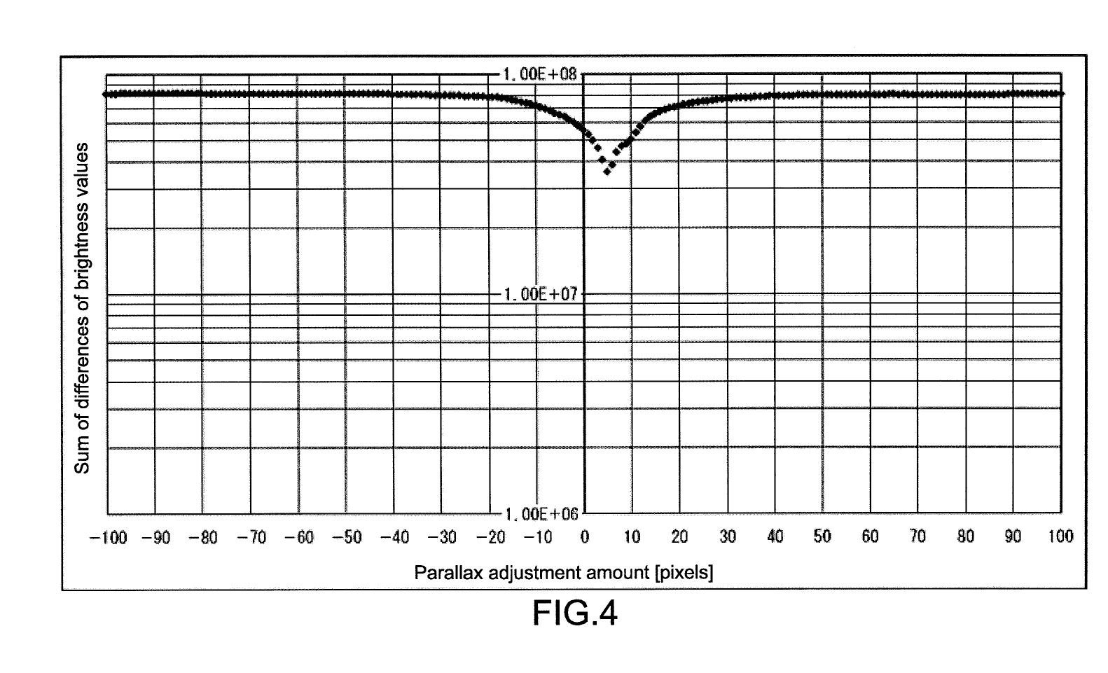

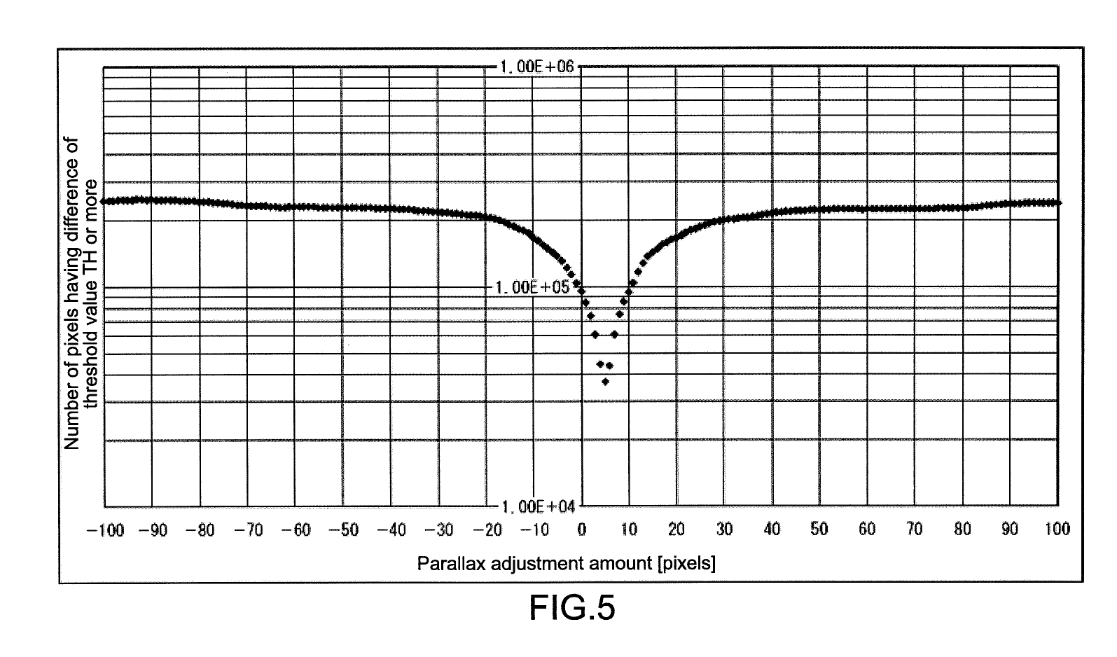

FIGS. 4 and 5 each show a parallax adjustment amount obtained when the first or second parallax amount adjustment processing is performed on the two-dimensional image for left eye and two-dimensional image for right eye that have a predetermined parallax amount.

FIG. 4 shows results of the first parallax amount adjustment processing. The horizontal axis of FIG. 4 shows an adjusted parallax amount (parallax adjustment amount) with an initial parallax amount of the input two-dimensional image for left eye and two-dimensional image for right eye as 0 (reference). The longitudinal axis of FIG. 4 shows the sum of differences between brightness values of pixels of the two-dimensional image for left eye and the two-dimensional image for right eye at each parallax adjustment amount.

FIG. 5 shows results of the second parallax amount adjustment processing. The horizontal axis of FIG. 5 shows an adjusted parallax amount similar to that of FIG. 4 and the longitudinal axis of FIG. 5 shows the number of pixels having a difference equal to or larger than a predetermined threshold value TH.

As shown in FIGS. 4 and 5, a parallax adjustment amount at which the sum of differences between brightness values or the number of pixels having a difference equal to or larger than a predetermined threshold value TH becomes smallest is certainly present. The image processing apparatus of each embodiment of the present invention changes a parallax amount of the input two-dimensional image for left eye and two-dimensional image for right eye into a parallax amount as described above at which the sum of differences between brightness values or the number of pixels having a difference equal to or larger than a predetermined threshold value TH becomes smallest. Accordingly, it is possible to generate a two-dimensional image for left eye and a two-dimensional image for right eye that are capable of reducing crosstalk more and present a viewer a three-dimensional image in which crosstalk is reduced more.

Hereinafter, modes for carrying out the present invention (hereinafter, referred to as embodiments of the present invention) will be described. It should be noted that descriptions will be given in the following order.

1. First embodiment (first structural example in which sum of brightness differences is minimized)
2. Second embodiment (second structural example in which number of pixels having predetermined brightness difference or more is minimized)
3. Third embodiment (first structural example having data format conversion function for three-dimensional image)
4. Fourth embodiment (second structural example having data format conversion function for three-dimensional image)
5. Fifth embodiment (first structural example in which region division is made)
6. Sixth embodiment (second structural example in which region division is made)
7. Seventh embodiment (structural example in which first and second parallax amount adjustment processing are selectable)
8. Eighth example (structural example of three-dimensional image display apparatus)

### 1. First Embodiment

### Structural Example of Image Processing Apparatus

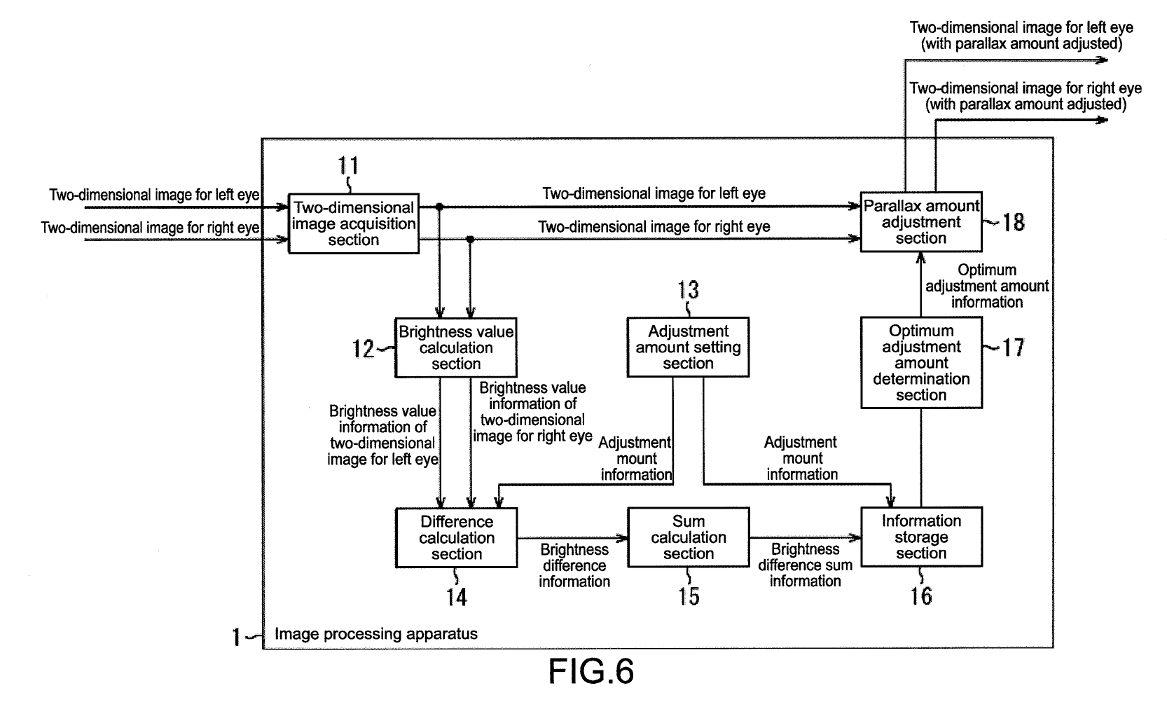

FIG. 6 shows a structural example of an image processing apparatus according to a first embodiment of the present invention.

An image processing apparatus 1 of FIG. 6 includes a two-dimensional image acquisition section 11, a brightness value calculation section 12, an adjustment amount setting section 13, a difference calculation section 14, a sum calculation section 15, an information storage section 16, an optimum adjustment amount determination section 17, and a parallax amount adjustment section 18.

The image processing apparatus 1 receives inputs of a two-dimensional image for left eye and a two-dimensional image for right eye that are perceived as a three-dimensional image by a viewer and adjusts (changes) a parallax amount provided to the two-dimensional image for left eye and two-dimensional image for right eye.

It should be noted that hereinafter, the two-dimensional image for left eye and the two-dimensional image for right eye that have been input are also referred to as an input two-dimensional image for left eye and an input two-dimensional image for right eye, respectively, in order to differentiate them from a two-dimensional image for left eye and a two-dimensional image for right eye obtained after the adjustment.

The two-dimensional image acquisition section 11 acquires (data of) the two-dimensional image for left eye and the two-dimensional image for right eye that are input from the outside and supplies them to the brightness value calculation section 12 and the parallax amount adjustment section 18.

The brightness value calculation section 12 calculates brightness values of individual pixels constituting the two-dimensional image for left eye and the two-dimensional image for right eye that have been supplied from the two-dimensional image acquisition section 11, and supplies them to the difference calculation section 14 as brightness value information. For example, the brightness value calculation section 12 converts each of the two-dimensional image for left eye and the two-dimensional image for right eye that are constituted of RGB signals into a brightness signal Y defined by ITU-R BT.709. Then, the brightness value calculation section 12 sets a value of the brightness signal Y (Y value) of each of the two-dimensional image for left eye and the two-dimensional image for right eye to be a brightness value of each pixel of each of the two-dimensional image for left eye and the two-dimensional image for right eye. It should be noted that a signal format of an image input from the outside may be a format other than the format constituted of RGB, and a brightness value may also be calculated by a method other than the method using the Y value.

The adjustment amount setting section 13 sets an adjustment amount of a parallax amount (parallax adjustment amount) and supplies it to the difference calculation section 14 and the information storage section 16 as adjustment amount information. For example, an adjustment range and an adjustment interval of the parallax amount can be input in an operation section (not shown), and the adjustment amount setting section 13 sets the adjustment amount based on the input adjustment range and adjustment interval.

Specifically, in a case where an adjustment range of “50” and an adjustment interval of “10” are input in the operation section, −50, −40, −30, −20, −10, 0, 10, 20, 30, 40, and 50 that include a parallax amount of the input two-dimensional image for left eye and the input two-dimensional image for right eye as a reference (0) are adjustment amounts.

Here, for example, the adjustment amount represents the number of shifted pixels of the two-dimensional image for right eye with the two-dimensional image for left eye as a reference, a positive adjustment amount represents a shift in a right direction, and a negative adjustment amount represents a shift in a left direction. When the adjustment amount is “50”, it represents that the two-dimensional image for left eye is left as it is as a reference and brightness values of pixels of the two-dimensional image for right eye are shifted in the right direction by 50 pixels. Then, when the parallax amount set in advance for the input two-dimensional image for left eye and the input two-dimensional image for right eye is denoted by P, a parallax amount of the two-dimensional image for left eye and two-dimensional image for right eye that have been adjusted with the adjustment amount of “50” becomes “P+50”.

It should be noted that the adjustment range and the adjustment interval of the parallax amount as the adjustment amount information may not be input in the operation section but determined and stored in advance. Further, the adjustment amount specified by the adjustment amount information may exist plurally with “0” as a reference.

The difference calculation section 14 uses a predetermined adjustment amount specified by the adjustment amount information to thus calculate differences between brightness values of corresponding pixels in the two-dimensional image for left eye and the two-dimensional image for right eye. The difference calculation section 14 then supplies absolute values of the calculated differences in brightness value to the sum calculation section 15. Hereinafter, the difference refers to an absolute value thereof.

For example, when the adjustment amount is “50”, differences between brightness values of corresponding pixels in a shifted two-dimensional image for right eye, in which the brightness values of the pixels of the input two-dimensional image for right eye are shifted in the right direction by 50 pixels, and the input two-dimensional image for left eye are calculated by the difference calculation section 14. Further, when the adjustment amount is “40”, differences between brightness values of corresponding pixels in a shifted two-dimensional image for right eye, in which the brightness values of the pixels of the input two-dimensional image for right eye are shifted in the right direction by 40 pixels, and the input two-dimensional image for left eye are calculated by the difference calculation section 14. In the same manner, differences between brightness values are calculated regarding each of “30”, . . . “−50”. The differences between brightness values of pixels for each adjustment amount, which are calculated by the difference calculation section 14, are supplied to the sum calculation section 15 as brightness difference information. It should be noted that when the brightness values are shifted by an adjustment amount, pixels that do not have corresponding brightness values between the shifted two-dimensional image for right eye and the input two-dimensional image for left eye are excluded from the calculation.

The sum calculation section 15 calculates a sum of differences between brightness values (brightness differences) of all pixels by using the differences between brightness values of pixels at a predetermined adjustment amount, which are supplied from the difference calculation section 14. Accordingly, the sum of brightness differences at the predetermined adjustment amount is obtained. The sum of brightness differences at the predetermined adjustment amount, which is obtained by the sum calculation section 15, is supplied to the information storage section 16 as brightness difference sum information.

In this embodiment, as described above, the sum of brightness differences is calculated from differences between brightness values of pixels at a predetermined adjustment amount in the sum calculation section 15, but the present invention is not limited thereto. For example, a variance of differences between brightness values or the like may be obtained. Further, since pixels that do not have corresponding brightness values between the shifted two-dimensional image for right eye and the input two-dimensional image for left eye are excluded from the calculation, a value obtained by dividing the sum of brightness differences by the number of pixels may be obtained as the brightness difference sum information, in order to eliminate an influence due to difference in the number of pixels.

As described above, the information storage section 16 is supplied with the adjustment amount information from the adjustment amount setting section 13. Further, the information storage section 16 is also supplied with the brightness difference sum information from the sum calculation section 15. The information storage section 16 stores a predetermined adjustment amount represented by the adjustment amount information and a sum of brightness differences represented by the brightness difference sum information in association with each other. As a result, regarding all adjustment amounts each of which is set based on an adjustment range and an adjustment interval, the information storage section 16 stores an adjustment amount and a sum of brightness differences in association with each other.

The optimum adjustment amount determination section 17 determines an optimum adjustment amount by judging (selecting) an adjustment amount at which a sum of brightness differences is smallest, from combinations of an adjustment amount and a sum of brightness differences that are stored in the information storage section 16. The determined adjustment amount is supplied to the parallax amount adjustment section 18 as optimum adjustment amount information. It should be noted that in a case where there are a plurality of values at which a sum of brightness differences is smallest, the optimum adjustment amount determination section 17 sets an adjustment amount having a smaller absolute value as an the optimum adjustment amount.

The parallax amount adjustment section 18 is supplied with the input two-dimensional image for left eye and the input two-dimensional image for right eye from the two-dimensional image acquisition section 11, and the optimum adjustment amount information from the optimum adjustment amount determination section 17. The parallax amount adjustment section 18 adjusts an adjustment amount specified by the optimum adjustment amount information with respect to the input two-dimensional image for left eye and the input two-dimensional image for right eye, and accordingly generates a two-dimensional image for left eye and a two-dimensional image for right eye that have a smallest sum of brightness differences. The generated two-dimensional image for left eye and two-dimensional image for right eye are output as a two-dimensional image for left eye and a two-dimensional image for right eye that have been subjected to parallax amount adjustment.

The image processing apparatus 1 is constituted as described above.

(Parallax Amount Adjustment Processing by Image Processing Apparatus 1 of FIG. 6)

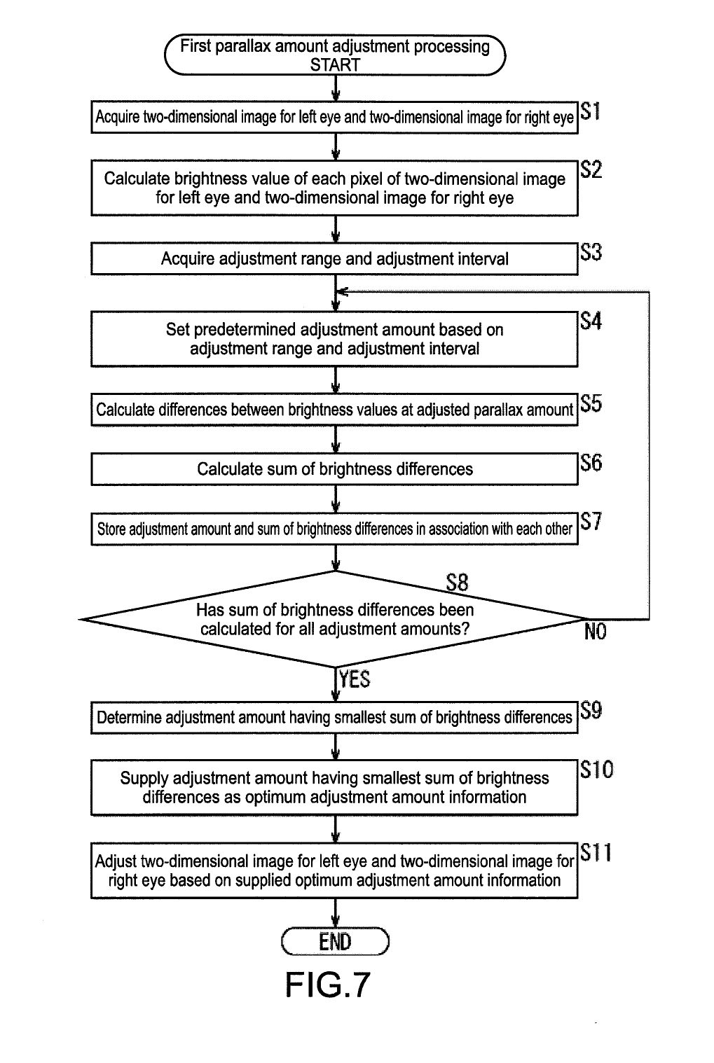

Next, with reference to a flowchart of FIG. 7, the first parallax amount adjustment processing executed by the image processing apparatus 1 of FIG. 6 will be described. This processing is started when a two-dimensional image for left eye and a two-dimensional image for right eye are supplied to the two-dimensional image acquisition section 11 of the image processing apparatus 1, for example.

First, in Step S1, the two-dimensional image acquisition section 11 acquires a two-dimensional image for left eye and a two-dimensional image for right eye that are input from the outside and supplies them to the brightness value calculation section 12 and the parallax amount adjustment section 18.

In Step S2, the brightness value calculation section 12 calculates brightness values of individual pixels constituting the two-dimensional image for left eye and the two-dimensional image for right eye that have been supplied from the two-dimensional image acquisition section 11, and supplies them to the difference calculation section 14 as brightness value information.

In Step S3, the adjustment amount setting section 13 acquires an adjustment range and an adjustment interval that are input in an operation section (not shown).

In Step S4, the adjustment amount setting section 13 sets a predetermined adjustment amount based on the acquired adjustment range and adjustment interval, and supplies the set adjustment amount to the difference calculation section 14 and the information storage section 16, as adjustment amount information. The difference calculation section 14 changes a parallax amount of the two-dimensional image for left eye and two-dimensional image for right eye by using the predetermined adjustment amount specified by the adjustment amount information. For example, in a case where the adjustment amount specified by the adjustment amount information is “50”, the difference calculation section 14 leaves the input two-dimensional image for left eye as it is and shifts brightness values of individual pixels of the input two-dimensional image for right eye in a right direction by 50 pixels.

In Step S5, the difference calculation section 14 calculates (absolute values of) differences between brightness values of the two-dimensional image for left eye and two-dimensional image for right eye at a parallax amount that has been adjusted by the adjustment amount supplied as the adjustment amount information, and then supplies the calculation results to the sum calculation section 15. In other words, the difference calculation section 14 calculates differences between brightness values of corresponding pixels in a shifted two-dimensional image for right eye, in which the brightness values of the pixels of the two-dimensional image for right eye are shifted by the adjustment amount supplied as the adjustment amount information, and the input two-dimensional image for left eye. The calculation results are supplied as brightness difference information to the sum calculation section 15.

In Step S6, the sum calculation section 15 calculates a sum of brightness differences at the parallax amount that has been adjusted. In other words, the sum calculation section 15 calculates a result obtained by adding differences between brightness values of all pixels of the shifted two-dimensional image for right eye and those of the input two-dimensional image for left eye. The calculation results are supplied from the sum calculation section 15 to the information storage section 16, as brightness difference sum information.

In Step S7, the information storage section 16 stores the predetermined adjustment amount specified by the adjustment amount information and the sum of brightness differences represented by the brightness difference sum information in association with each other.

In Step S8, the adjustment amount setting section 13 judges whether the sum of brightness differences has been calculated regarding all adjustment amounts specified based on the adjustment range and the adjustment interval.

When it is judged in Step S8 that the sum of brightness differences has not been calculated regarding all the adjustment amounts, the processing returns to Step S4 and the processing from Step S4 to Step S8 are repeated. That is, an adjustment amount that has not been set yet is supplied to the difference calculation section 14 and the information storage section 16 as adjustment amount information, and a sum of brightness differences at the predetermined adjustment amount are then calculated.

On the other hand, when it is judged in Step S8 that the sum of brightness differences has been obtained regarding all the adjustment amounts, the processing proceeds to Step S9. In Step S9, the optimum adjustment amount determination section 17 determines an adjustment amount at which a sum of brightness differences is smallest, from combinations of the adjustment amount and the sum of brightness differences that are stored in the information storage section 16. Then, in Step S10, the optimum adjustment amount determination section 17 supplies, as optimum adjustment amount information, the adjustment amount at which a sum of brightness differences is smallest to the parallax amount adjustment section 18.

In Step S11, the parallax amount adjustment section 18 adjusts the input two-dimensional image for left eye and the input two-dimensional image for right eye based on the supplied optimum adjustment amount information. In other words, the parallax amount adjustment section 18 generates a two-dimensional image for left eye and a two-dimensional image for right eye in which a parallax amount of the two-dimensional image for left eye and two-dimensional image for right eye after the adjustment becomes “parallax amount P of the input two-dimensional image for left eye and input two-dimensional image for right eye+optimum adjustment amount”. Then, the parallax amount adjustment section 18 outputs the generated two-dimensional image for left eye and two-dimensional image for right eye and terminates the processing.

As described above, the image processing apparatus 1 of the first embodiment outputs a two-dimensional image for left eye and a two-dimensional image for right eye in which a parallax amount is adjusted so that a sum of brightness differences becomes smallest. In the two-dimensional image for left eye and two-dimensional image for right eye that have a smallest sum of brightness differences, an area having a brightness difference perceived as crosstalk is suppressed from being generated. Accordingly, it is possible to display a three-dimensional image in which crosstalk is reduced more owing to a two-dimensional image for left eye and a two-dimensional image for right eye having a smallest sum of brightness differences.

### 2. Second Embodiment

Next, an image processing apparatus according to a second embodiment will be described.

(Structural Example of Image Processing Apparatus)

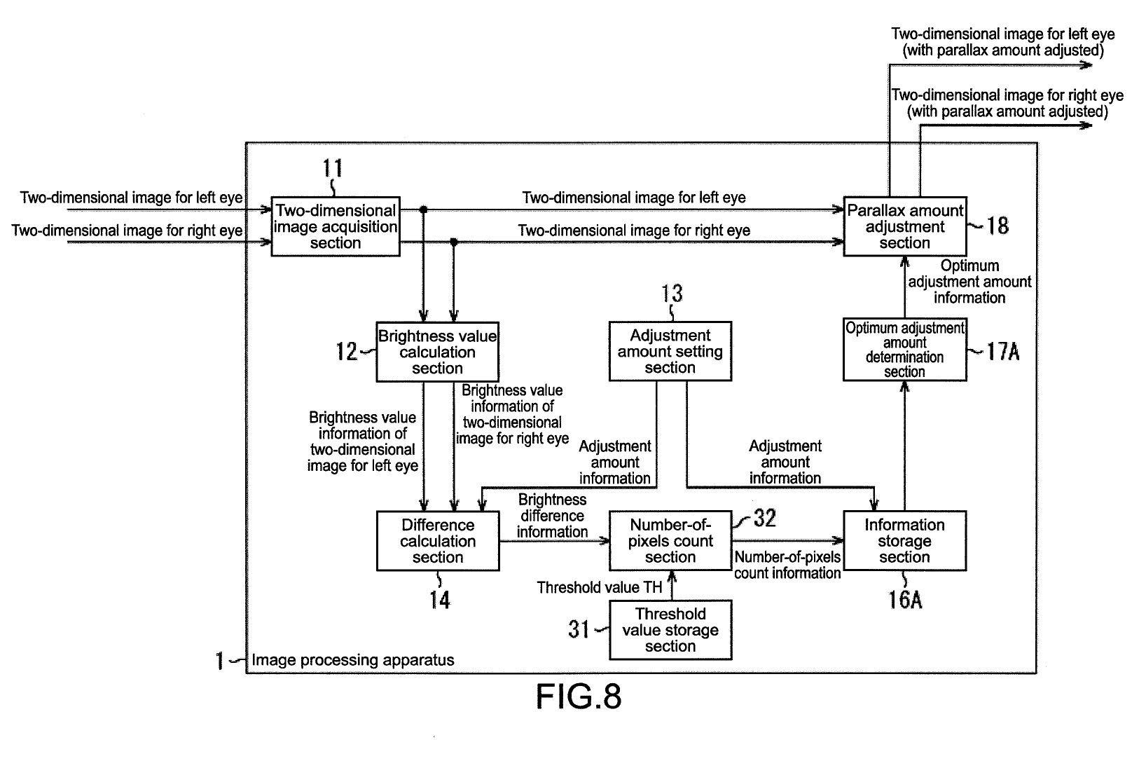

FIG. 8 shows a structural example of the image processing apparatus according to the second embodiment of the present invention.

An image processing apparatus 1 of FIG. 8 includes the two-dimensional image acquisition section 11, the brightness value calculation section 12, the adjustment amount setting section 13, the difference calculation section 14, an information storage section 16A, an optimum adjustment amount determination section 17A, the parallax amount adjustment section 18, a threshold value storage section 31, and a number-of-pixels count section 32.

In FIG. 8, portions corresponding to those of FIG. 6 are denoted by the same reference symbols and descriptions thereof will be omitted as appropriate.

That is, the image processing apparatus 1 of FIG. 8 is provided with the threshold value storage section 31 and the number-of-pixels count section 32 instead of the sum calculation section 15 of FIG. 6. Further, the information storage section 16 and the optimum adjustment amount determination section 17 are replaced with the information storage section 16A and the optimum adjustment amount determination section 17A that meet processing of the number-of-pixels count section 32.

The threshold value storage section 31 stores a threshold value TH used for counting the number of pixels in the number-of-pixels count section 32. As the threshold value TH, a predetermined value or a value input in the operation section (not shown) or the like may be stored.

The number-of-pixels count section 32 is supplied with differences between brightness values of pixels at a predetermined adjustment amount, from the difference calculation section 14. Further, the number-of-pixels count section 32 is supplied with a threshold value TH from the threshold value storage section 31. The number-of-pixels count section 32 counts the number of pixels having a difference between brightness values that is equal to or larger than the threshold value TH. The number-of-pixels count section 32 then supplies the counted number of pixels as number-of-pixels count information to the information storage section 16A.

The information storage section 16A stores an adjustment amount and the number of pixels having a difference equal to or larger than the threshold value TH when a parallax amount is adjusted with that adjustment amount in association with each other, based on the number-of-pixels count information supplied from the number-of-pixels count section 32 and the adjustment amount information supplied from the adjustment amount setting section 13. As a result, the information storage section 16A stores an adjustment amount and the number of pixels in association with each other regarding all adjustment amounts that are set based on the adjustment range and the adjustment interval.

The optimum adjustment amount determination section 17A determines an optimum adjustment amount by judging (selecting) an adjustment amount at which the number of pixels is smallest from combinations of an adjustment amount and the number of pixels that are stored in the information storage section 16A. The determined adjustment amount is supplied, as optimum adjustment amount information, to the parallax amount adjustment section 18.

The image processing apparatus 1 according to the second embodiment is structured as described above.

(Parallax Amount Adjustment Processing by Image Processing Apparatus 1 of FIG. 8)

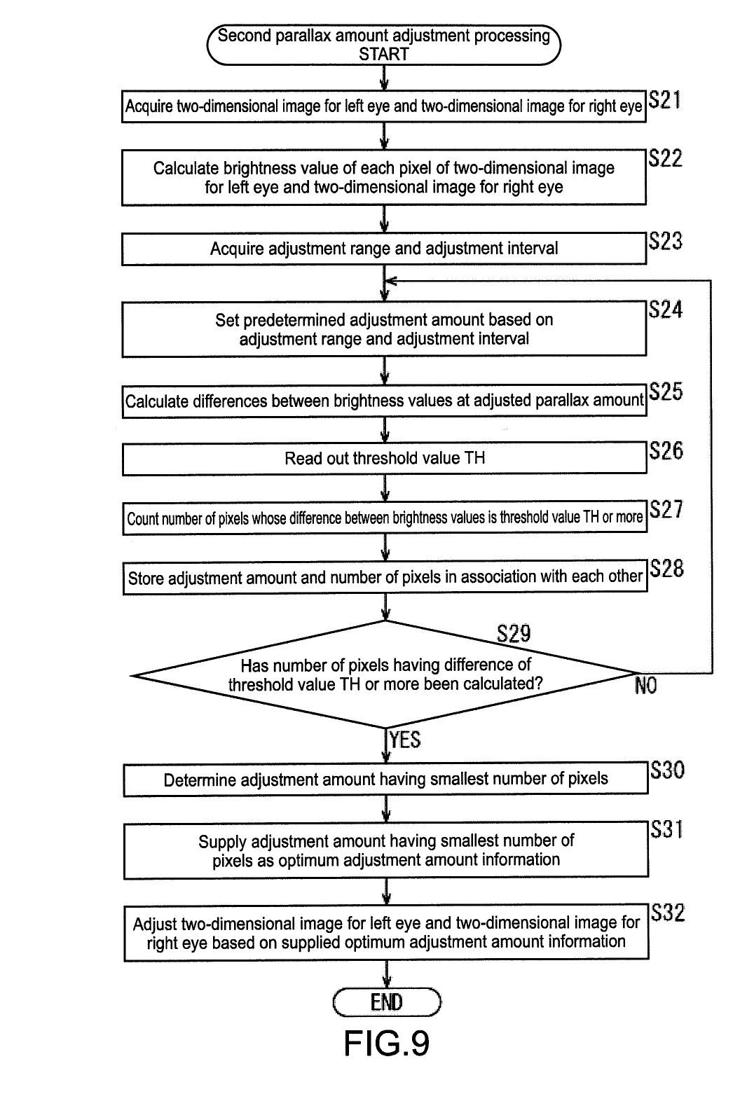

Next, with reference to a flowchart of FIG. 9, the second parallax amount adjustment processing executed by the image processing apparatus 1 of FIG. 8 will be described. This processing is started when a two-dimensional image for left eye and a two-dimensional image for right eye are supplied to the two-dimensional image acquisition section 11 of the image processing apparatus 1, for example.

Processing from Steps S21 to S25 are the same as those of Steps S1 to S5 described above and accordingly descriptions thereof will be omitted.

In Step S26, the number-of-pixels count section 32 reads out a threshold value TH stored in the threshold value storage section 31. In Step S27, the number-of-pixels count section 32 then compares a difference between brightness values and the threshold value TH with each other for each pixel, and counts the number of pixels having a difference between brightness values that is equal to or larger than the threshold value TH. The count results are supplied, as number-of-pixels count information, to the information storage section 16A.

In Step S28, the information storage section 16A stores the adjustment amount represented by the adjustment amount information supplied from the adjustment amount setting section 13 and the number of pixels represented by the number-of-pixels count information supplied from the number-of-pixels count section 32 in association with each other.

In Step S29, the adjustment amount setting section 13 judges whether the number of pixels having a difference between brightness values that is equal to or larger than the threshold value TH has been obtained regarding all adjustment amounts specified based on the adjustment range and the adjustment interval. When it is judged in Step S29 that the number of pixels having a difference equal to or larger than the threshold value TH has not been obtained regarding all the adjustment amounts, the processing returns to Step S24 and the processing from Steps S24 to S29 are repeated. That is, an adjustment amount that has not been set yet is supplied, as adjustment amount information, to the difference calculation section 14 and the information storage section 16A, and the number of pixels having a difference equal to or larger than the threshold value TH at a predetermined adjustment amount is then calculated.

On the other hand, when it is judged in Step S29 that the number of pixels having a difference equal to or larger than the threshold value TH has been obtained regarding all the adjustment amounts specified based on the adjustment range and the adjustment interval, the processing proceeds to Step S30. In Step S30, the optimum adjustment amount determination section 17A determines an adjustment amount at which the number of pixels is smallest from combinations of the adjustment amount and the number of pixels that are stored in the information storage section 16A. Then, in Step S31, the optimum adjustment amount determination section 17A supplies the adjustment amount at which the number of pixels is smallest to the parallax amount adjustment section 18 as optimum adjustment amount information.

In Step S32, the parallax amount adjustment section 18 adjusts the input two-dimensional image for left eye and the input two-dimensional image for right eye based on the supplied optimum adjustment amount information, as in the processing of Step S11 in FIG. 7, and terminates the processing.

As described above, the image processing apparatus 1 of the second embodiment outputs a two-dimensional image for left eye and a two-dimensional image for right eye in which a parallax amount is adjusted so that the number of pixels having a difference between brightness values that is equal to or larger than the threshold value TH becomes smallest. In the two-dimensional image for left eye and two-dimensional image for right eye that have a smallest number of pixels having a difference between brightness values that is equal to or larger than the threshold value TH, an area having a brightness difference perceived as crosstalk is suppressed from being generated. Accordingly, it is possible to display a three-dimensional image in which crosstalk is reduced more owing to a two-dimensional image for left eye and a two-dimensional image for right eye that have a smallest number of pixels having a difference between brightness values that is equal to or larger than the threshold value TH.

(Numerical Example of First Parallax Amount Adjustment Processing and Second Parallax Amount Adjustment Processing)

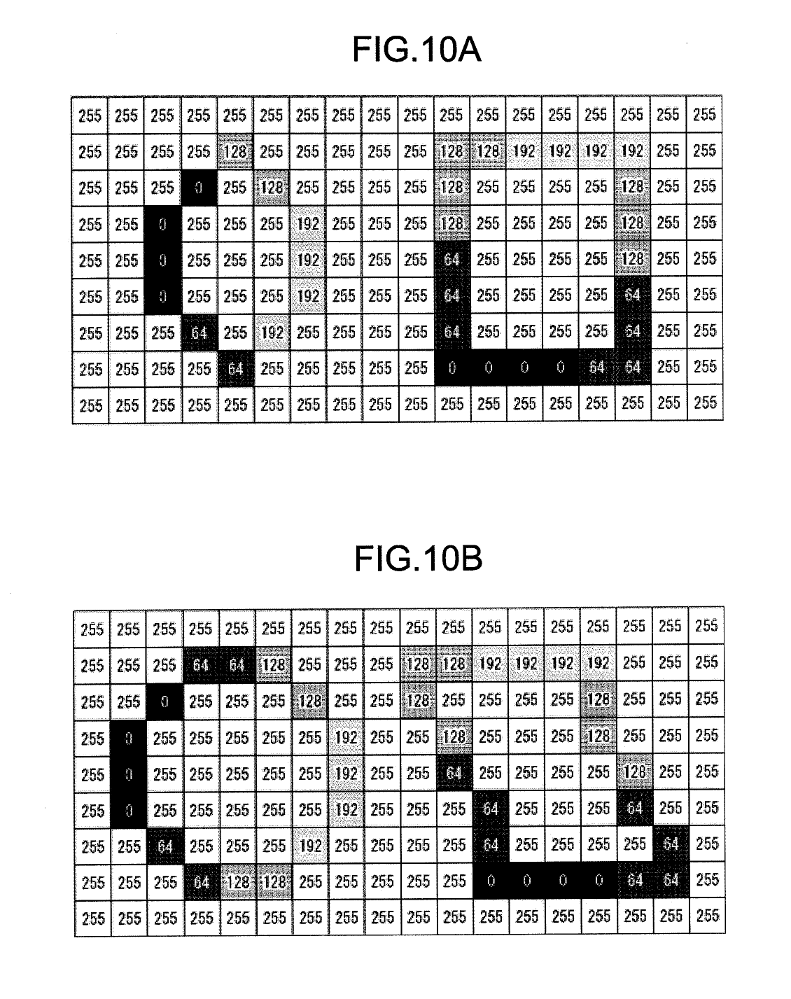

Next, the first parallax amount adjustment processing and the second parallax amount adjustment processing described above will be further described with reference to FIGS. 10 to 15.

First, the first parallax amount adjustment processing is described.

It is assumed that a two-dimensional image for left eye and a two-dimensional image for right eye are input to the image processing apparatus 1, each of the images having 162 pixels in total formed of 18 pixels arranged in a horizontal direction and 9 pixels arranged in a vertical direction. The brightness value calculation section 12 calculates a brightness value of each pixel of the respective two-dimensional image for left eye and two-dimensional image for right eye.

FIG. 10 show the brightness values of pixels of the two-dimensional image for left eye and the two-dimensional image for right eye, the brightness values being calculated by the brightness value calculation section 12.

FIG. 10A shows brightness values of pixels of the two-dimensional image for left eye, and FIG. 10B shows brightness values of pixels of the two-dimensional image for right eye.

The adjustment amount setting section 13 sets −2, −1, 0, +1, and +2 as adjustment amounts, based on a predetermined adjustment range and adjustment interval. For example, the adjustment amount setting section 13 first supplies an adjustment amount of “0” as adjustment amount information to the difference calculation section 14 and the information storage section 16.

Using the adjustment amount of “0” specified by the adjustment amount information, the difference calculation section 14 calculates differences between brightness values of corresponding pixels in the two-dimensional image for left eye and the two-dimensional image for right eye. Since the adjustment amount is “0”, the difference calculation section 14 calculates differences between brightness values of corresponding pixels in the two-dimensional image for left eye and the two-dimensional image for right eye as they are, which have been input to the image processing apparatus 1.

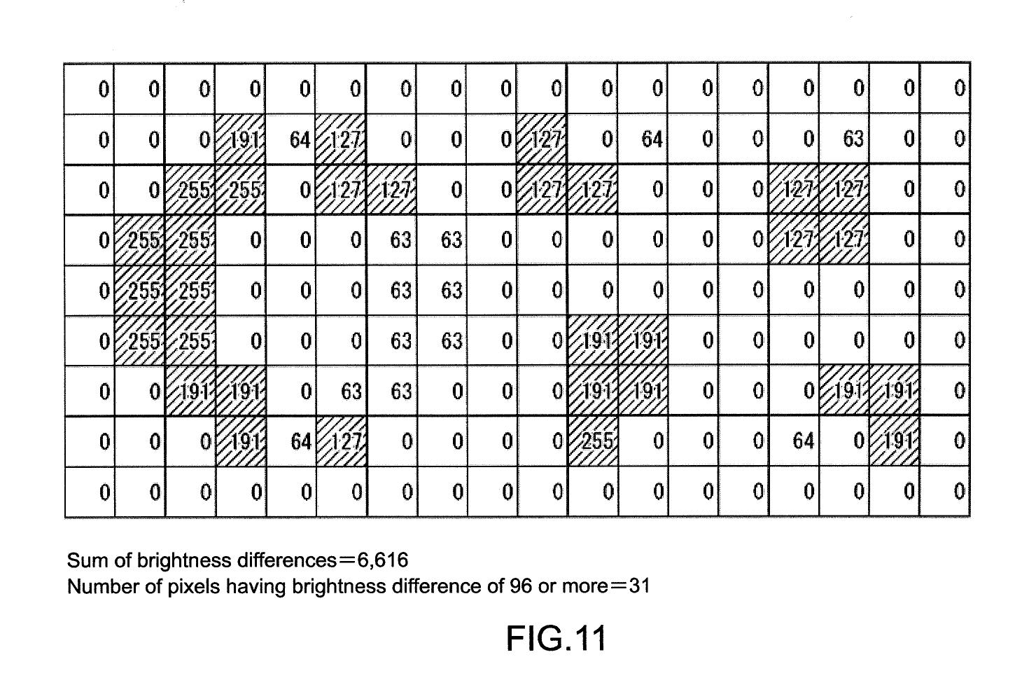

FIG. 11 shows differences between brightness values of pixels that are calculated by the difference calculation section 14 in the case where the adjustment amount is “0”.

The calculated differences between brightness values of pixels are supplied to the sum calculation section 15. Using the differences between brightness values of pixels at the adjustment amount of “0”, which are supplied from the difference calculation section 14, the sum calculation section 15 calculates a sum of the differences between brightness values regarding all pixels (sum of brightness differences). When a sum of the brightness differences with respect to the differences between the brightness values of pixels shown in FIG. 11 are calculated, a calculation result of “6,616” is obtained. The calculation result of “6,616” is supplied to the information storage section 16 as brightness difference sum information.

The information storage section 16 is supplied with the adjustment amount of “0” as the adjustment amount information from the adjustment amount setting section 13 and with “6,616” as the brightness difference sum information from the sum calculation section 15. The information storage section 16 stores the adjustment amount of “0” and the sum of the brightness differences of “6,616” in association with each other.

Next, for example, an adjustment amount of “−2” as adjustment amount information is supplied to the difference calculation section 14 and the information storage section 16.

Using the adjustment amount of “−2” specified by the adjustment amount information, the difference calculation section 14 calculates differences between brightness values of corresponding pixels in the two-dimensional image for left eye and the two-dimensional image for right eye. That is, the difference calculation section 14 generates a shifted two-dimensional image for right eye, in which the brightness values of pixels of the two-dimensional image for right eye are shifted in a left direction by 2 pixels. Then, the difference calculation section 14 calculates differences between brightness values of corresponding pixels in the shifted two-dimensional image for right eye and the two-dimensional image for left eye.

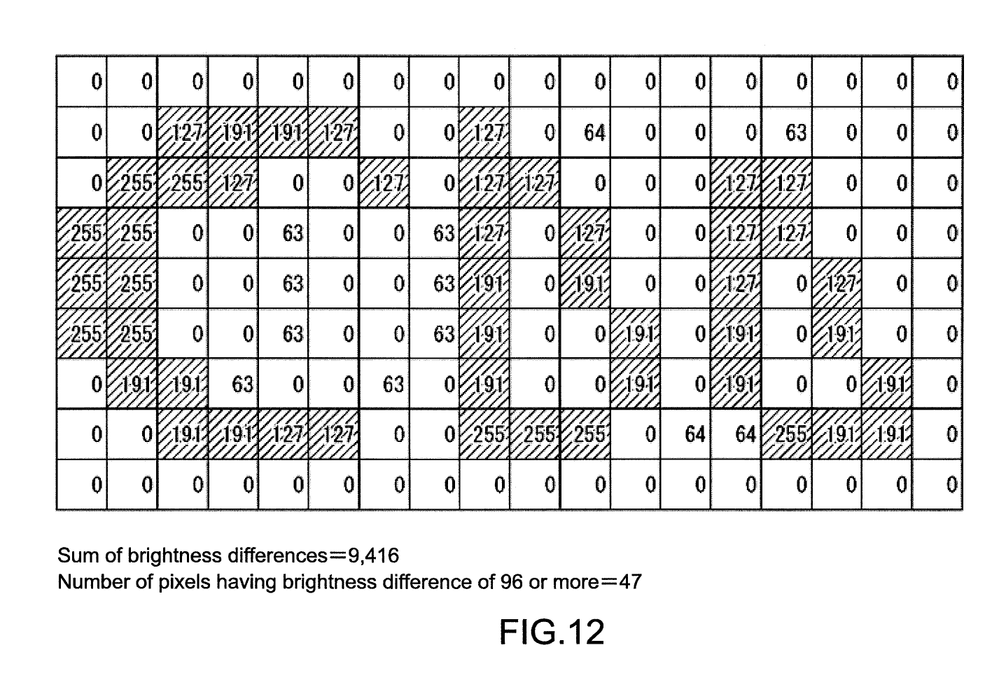

FIG. 12 shows differences between brightness values of pixels that are calculated by the difference calculation section 14 in the case where the adjustment amount is “−2”.

Then, a sum of the brightness differences with respect to the differences between the brightness values of pixels shown in FIG. 12 are calculated by the sum calculation section 15. When the sum of the brightness differences is calculated with respect to the differences between the brightness values of FIG. 12, a calculation result is “9,416”.

The information storage section 16 is supplied with the adjustment amount of “−2” as adjustment amount information from the adjustment amount setting section 13 and with “9,416” as brightness difference sum information from the sum calculation section 15. The information storage section 16 stores the adjustment amount of “−2” and the sum of the brightness differences of “9,416” in association with each other.

In this way, adjustment amounts of “−1”, “+1”, and “+2” are sequentially supplied as adjustment amount information from the adjustment amount setting section 13 to the difference calculation section 14 and the information storage section 16 hereinafter.

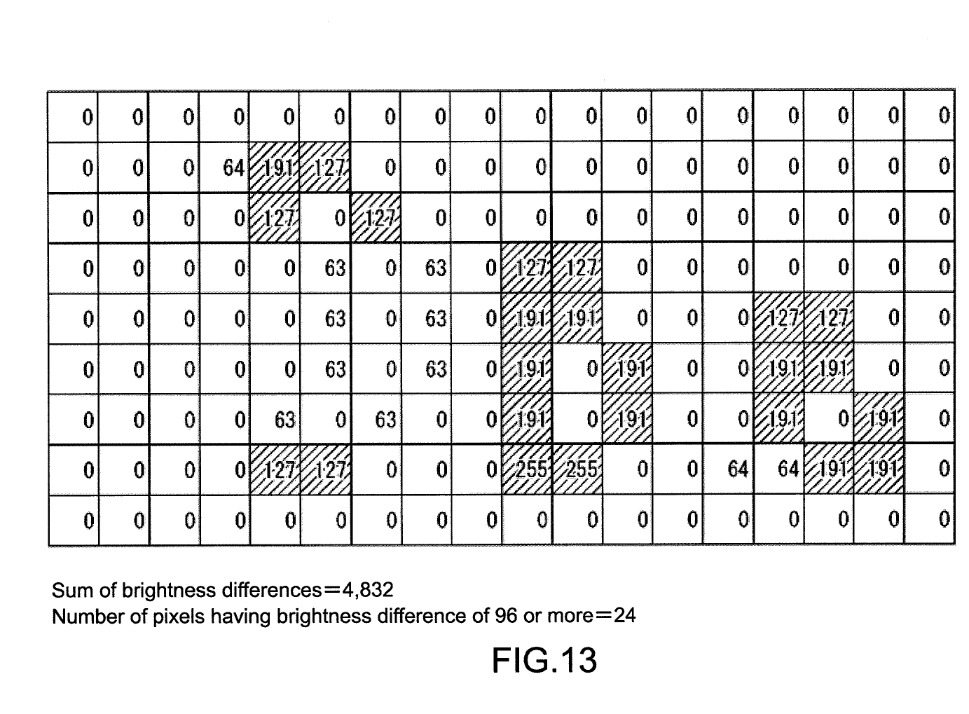

FIG. 13 shows differences between brightness values of pixels that are calculated by the difference calculation section 14 in the case where the adjustment amount is “−1”. With respect to the differences between the brightness values of pixels shown in FIG. 13, “4,832” is obtained as a sum of the brightness differences. The information storage section 16 stores the adjustment amount of “−1” and the sum of the brightness differences of “4,832” in association with each other.

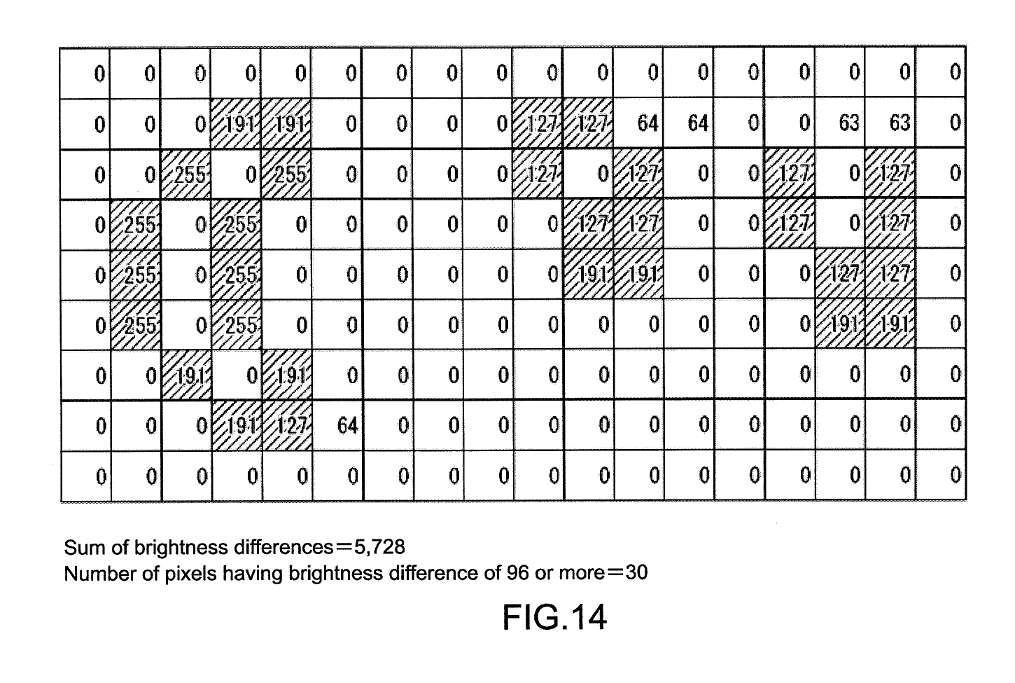

FIG. 14 shows differences between brightness values of pixels that are calculated by the difference calculation section 14 in the case where the adjustment amount is “+1”. With respect to the differences between the brightness values of pixels shown in FIG. 14, “5,728” is obtained as a sum of the brightness differences. The information storage section 16 stores the adjustment amount of “+1” and the sum of the brightness differences of “5,728” in association with each other.

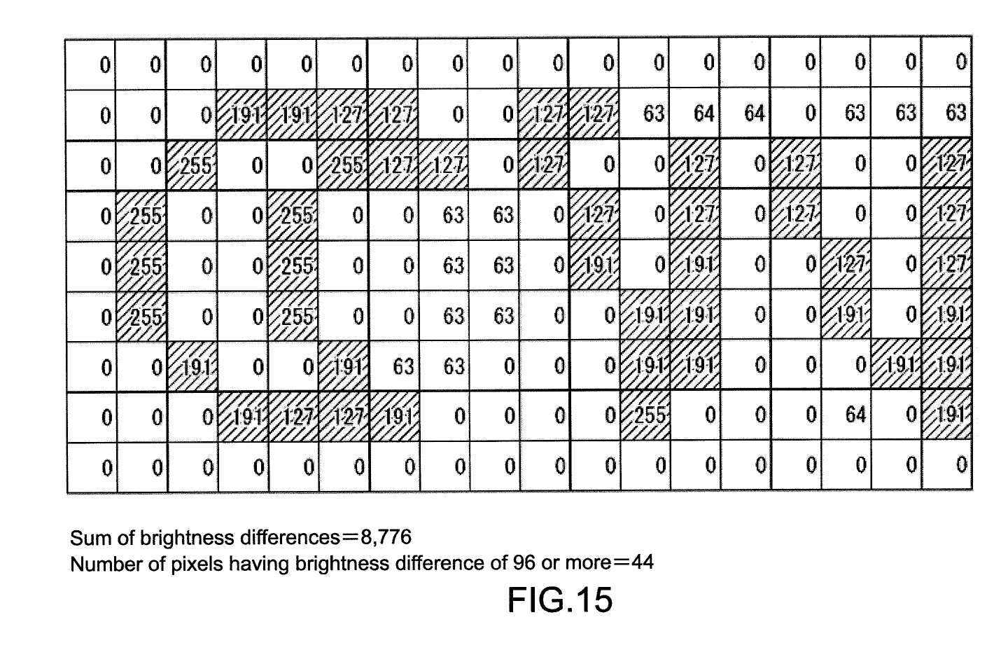

FIG. 15 shows differences between brightness values of pixels that are calculated by the difference calculation section 14 in the case where the adjustment amount is “+2”. With respect to the differences between the brightness values of pixels shown in FIG. 15, “8,776” is obtained as a sum of the brightness differences. The information storage section 16 stores the adjustment amount of “+2” and the sum of the brightness differences of “8,776” in association with each other.

The optimum adjustment amount determination section 17 determines an adjustment amount at which a sum of the brightness differences is smallest, from combinations of the adjustment amount and the sum of the brightness differences that are stored in the information storage section 16. At the moment, a pair of the adjustment amount of “0” and the sum of the brightness differences of “6,616”, a pair of the adjustment amount of “−2” and the sum of the brightness differences of “9,416”, a pair of the adjustment amount of “−1” and the sum of the brightness differences of “4,832”, a pair of the adjustment amount of “+1” and the sum of the brightness differences of “5,728”, and a pair of the adjustment amount of “+2” and the sum of the brightness differences of “8,776” are stored in the information storage section 16. Of those, the optimum adjustment amount determination section 17 determines the adjustment amount of “−1” that corresponds to the smallest sum of the brightness differences of “4,832” to be an optimum adjustment amount, and supplies it to the parallax amount adjustment section 18 as optimum adjustment amount information.

The parallax amount adjustment section 18 adjusts the input two-dimensional image for left eye and the input two-dimensional image for right eye with the adjustment amount of “−1” as the optimum adjustment amount information, and accordingly generates a two-dimensional image for left eye and a two-dimensional image for right eye having a smallest sum of the brightness differences.

Next, the second parallax amount adjustment processing is described.

The second parallax amount adjustment processing is the same as the above first parallax amount adjustment processing up to a step in which the differences between brightness values of pixels shown in FIGS. 11 to 15 are obtained by the difference calculation section 14.

The threshold value storage section 31 stores “96” as a threshold value TH that is used for counting the number of pixels in the number-of-pixels count section 32. “96” as a threshold value TH is read out by the number-of-pixels count section 32.

Then, the number-of-pixels count section 32 counts the number of pixels having a difference between brightness values of pixels that is equal to or larger than the threshold value TH of “96” at the adjustment amount of “0” shown in FIG. 11. As a result, “31” is obtained as the number of pixels.

In the case where the adjustment amount is “−2”, the number of pixels having a difference between brightness values of pixels that is equal to or larger than the threshold value TH of “96” is counted at the adjustment amount of “−2” shown in FIG. 12, and “47” is obtained as the number of pixels.

In the case where the adjustment amount is “−1”, the number of pixels having a difference between brightness values of pixels that is equal to or larger than the threshold value TH of “96” is counted at the adjustment amount of “−1” shown in FIG. 13, and “24” is obtained as the number of pixels.

In the case where the adjustment amount is “+1”, the number of pixels having a difference between brightness values of pixels that is equal to or larger than the threshold value TH of “96” is counted at the adjustment amount of “+1” shown in FIG. 14, and “30” is obtained as the number of pixels.

In the case where the adjustment amount is “+2”, the number of pixels having a difference between brightness values of pixels that is equal to or larger than the threshold value TH of “96” is counted at the adjustment amount of “+2” shown in FIG. 15, and “44” is obtained as the number of pixels.

As a result, a pair of the adjustment amount of “0” and the number of pixels of “31”, a pair of the adjustment amount of “−2” and the number of pixels of “47”, a pair of the adjustment amount of “−1” and the number of pixels of “24”, a pair of the adjustment amount of “+1” and the number of pixels of “30”, and a pair of the adjustment amount of “+2” and the number of pixels of “44” are stored in the information storage section 16A. Of those, the optimum adjustment amount determination section 17A determines the adjustment amount of “−1” that corresponds to the smallest number of pixels of “24” to be an optimum adjustment amount, and supplies it to the parallax amount adjustment section 18 as optimum adjustment amount information.

The parallax amount adjustment section 18 adjusts the input two-dimensional image for left eye and the input two-dimensional image for right eye with the adjustment amount of “−1” as the optimum adjustment amount information, and accordingly generates a two-dimensional image for left eye and a two-dimensional image for right eye having a smallest number of pixels.

### 3. Third Embodiment

Next, an image processing apparatus according to a third embodiment will be described.

In the third embodiment, the image processing apparatus that performs the first parallax amount adjustment processing has a data format conversion function for a three-dimensional image. In other words, the image processing apparatus can convert data formats between a first three-dimensional image constituted of a two-dimensional image for left eye and a two-dimensional image for right eye and a second three-dimensional image different from the first three-dimensional image. Accordingly, it is possible to deal with input and output of three-dimensional image data in various formats.

(Structural Example of Image Processing Apparatus)

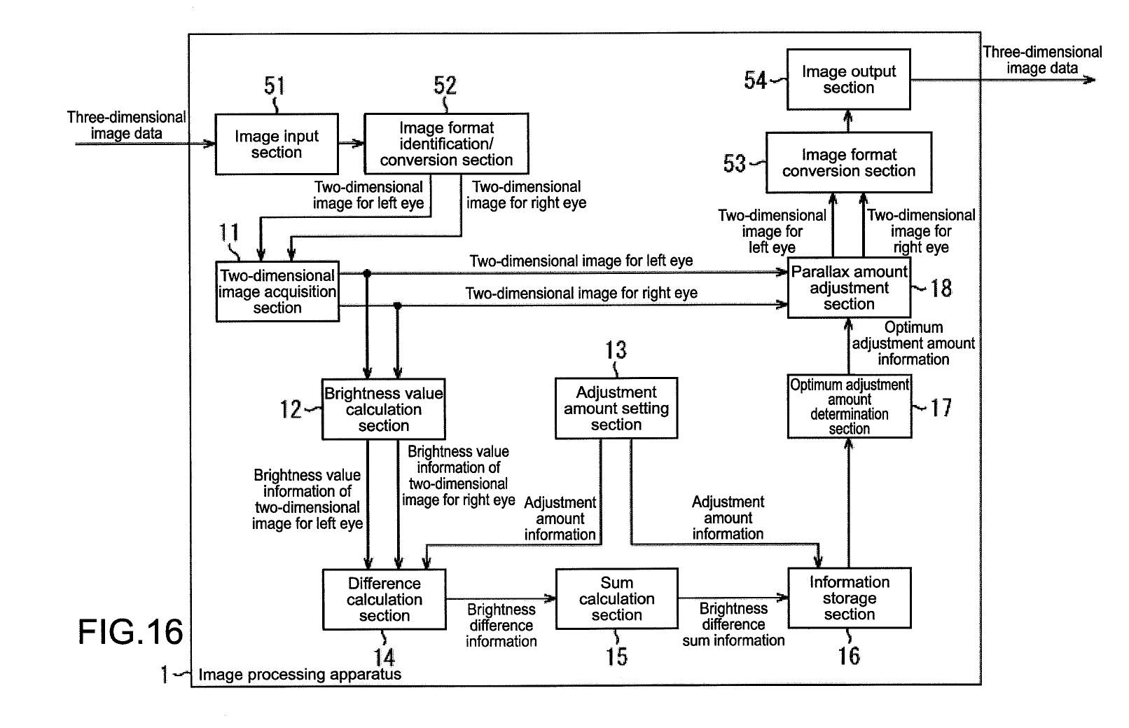

FIG. 16 shows a structural example of the image processing apparatus according to the third embodiment of the present invention.

An image processing apparatus 1 of FIG. 16 includes an image input section 51, an image format identification/conversion section 52, an image format conversion section 53, and an image output section 54 in addition to the same structure as that of FIG. 6. Descriptions on portions of the same structure as those of FIG. 6 are omitted.

The two-dimensional image for left eye and the two-dimensional image for right eye are input in the above first embodiment, but the image input section 51 is input with data of three-dimensional images (three-dimensional image data) in various formats.

For example, examples of the format of a three-dimensional image input to the image input section 51 include a format constituted of the two-dimensional image for left eye and two-dimensional image for right eye described above. Further, as other formats of a three-dimensional image, a format constituted of any of a two-dimensional image for left eye and a two-dimensional image for right eye as a reference and another image represented by a difference between the two-dimensional images, and a format constituted of a two-dimensional image and its depth information.

The image input section 51 supplies the input three-dimensional image data to the image format identification/conversion section 52.

The image format identification/conversion section 52 identifies a format of the three-dimensional image data supplied from the image input section 51. In a case where the format of the three-dimensional image data is not constituted of a two-dimensional image for left eye and a two-dimensional image for right eye, the image format identification/conversion section 52 then converts the format into a format constituted of a two-dimensional image for left eye and a two-dimensional image for right eye, and supplies it to the two-dimensional image acquisition section 11.

The image format conversion section 53 is supplied with the two-dimensional image for left eye and two-dimensional image for right eye that have been subjected to the parallax amount adjustment from the parallax amount adjustment section 18. The image format conversion section 53 converts the three-dimensional image data having the format constituted of the supplied two-dimensional image for left eye and the two-dimensional image for right eye into a format appropriate for output, and supplies it to the image output section 54. The format of the three-dimensional image data after the conversion is determined by a setting of an operator in the operation section. Further, in a case where the image output section 54 is connected through an HDMI (High-Definition Multimedia Interface) (registered trademark) or the like, the image format conversion section 53 may acquire a format with which an apparatus connected at a subsequent stage can perform input, from control information contained in an HDMI signal, for example. In a case where the format of the three-dimensional image data is not necessary to be converted, the image format conversion section 53 supplies the image output section 54 with (the data of) the two-dimensional image for left eye and two-dimensional image for right eye that have been subjected to the parallax amount adjustment as they are.

The image output section 54 outputs the three-dimensional image data supplied from the image format conversion section 53 to an apparatus at a subsequent stage, such as a display apparatus.

According to the image processing apparatus 1 of FIG. 16, the three-dimensional image data in various formats can be input, and the input three-dimensional image data is converted into the format constituted of the two-dimensional image for left eye and the two-dimensional image for right eye. Next, a parallax amount is adjusted so that a sum of brightness differences becomes smallest, and adjusted two-dimensional image for left eye and two-dimensional image for right eye are generated. Then, the generated two-dimensional image for left eye and two-dimensional image for right eye are converted into the three-dimensional image data of a format appropriate for an apparatus at a subsequent stage and are thus output.

Accordingly, it is possible to deal with input and output of three-dimensional image data in various formats and display a three-dimensional image in which crosstalk is reduced more.

### 4. Fourth Embodiment

Next, an image processing apparatus according to a fourth embodiment will be described.

In the fourth embodiment, the image processing apparatus that performs the second parallax amount adjustment processing has a data format conversion function for a three-dimensional image.

(Structural Example of Image Processing Apparatus)

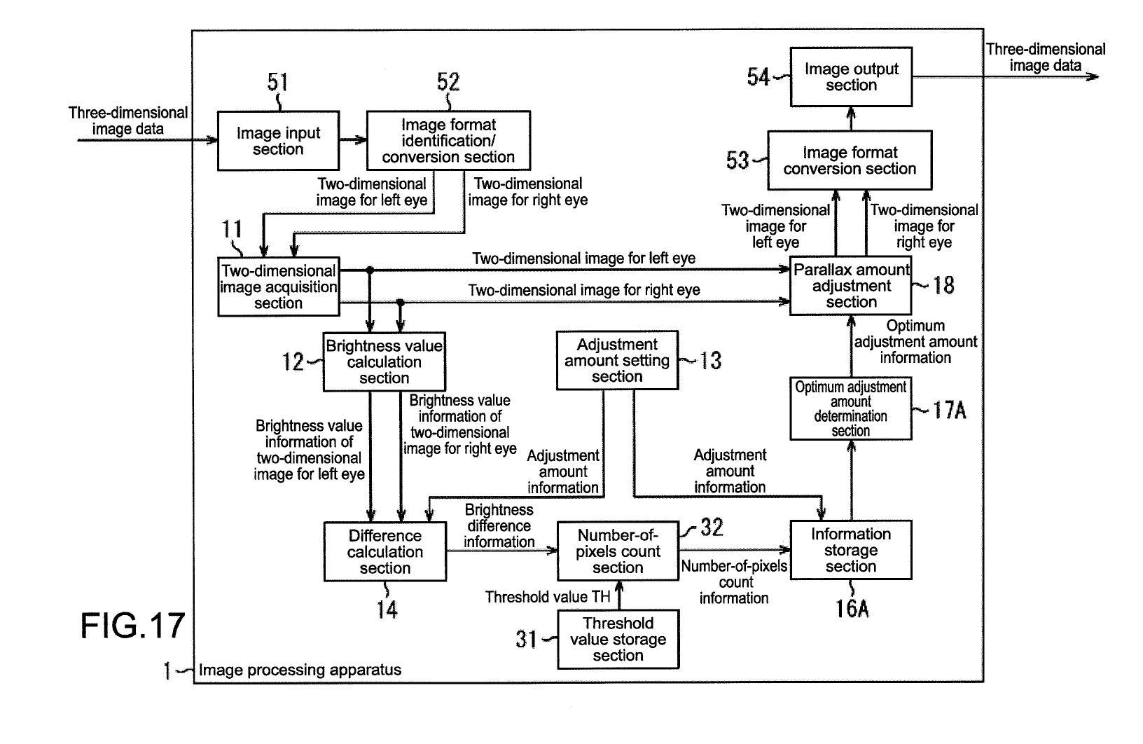

FIG. 17 shows a structural example of the image processing apparatus according to the fourth embodiment of the present invention.

An image processing apparatus 1 of FIG. 17 includes the image input section 51, the image format identification/conversion section 52, the image format conversion section 53, and the image output section 54 that are shown in FIG. 16, in addition to the same structure as that of FIG. 8.

Structures of the image processing apparatus 1 of FIG. 17 are the same as corresponding blocks of FIG. 8 or FIG. 16, and therefore descriptions thereof are omitted.

According to the image processing apparatus 1 of FIG. 17, three-dimensional image data in various formats can be input and the input three-dimensional image data is converted into a format constituted of a two-dimensional image for left eye and a two-dimensional image for right eye. Next, a parallax amount is adjusted so that the number of pixels having a difference equal to or larger than the threshold value TH becomes smallest, and adjusted two-dimensional image for left eye and two-dimensional image for right eye are generated. Then, the generated two-dimensional image for left eye and two-dimensional image for right eye are converted into a three-dimensional image data of a format appropriate for an apparatus at a subsequent stage and are output.

Accordingly, it is possible to deal with input and output of three-dimensional image data in various formats and display a three-dimensional image in which crosstalk is reduced more.

### 5. Fifth Embodiment

Next, an image processing apparatus according to a fifth embodiment will be described.

(Structural Example of Image Processing Apparatus)

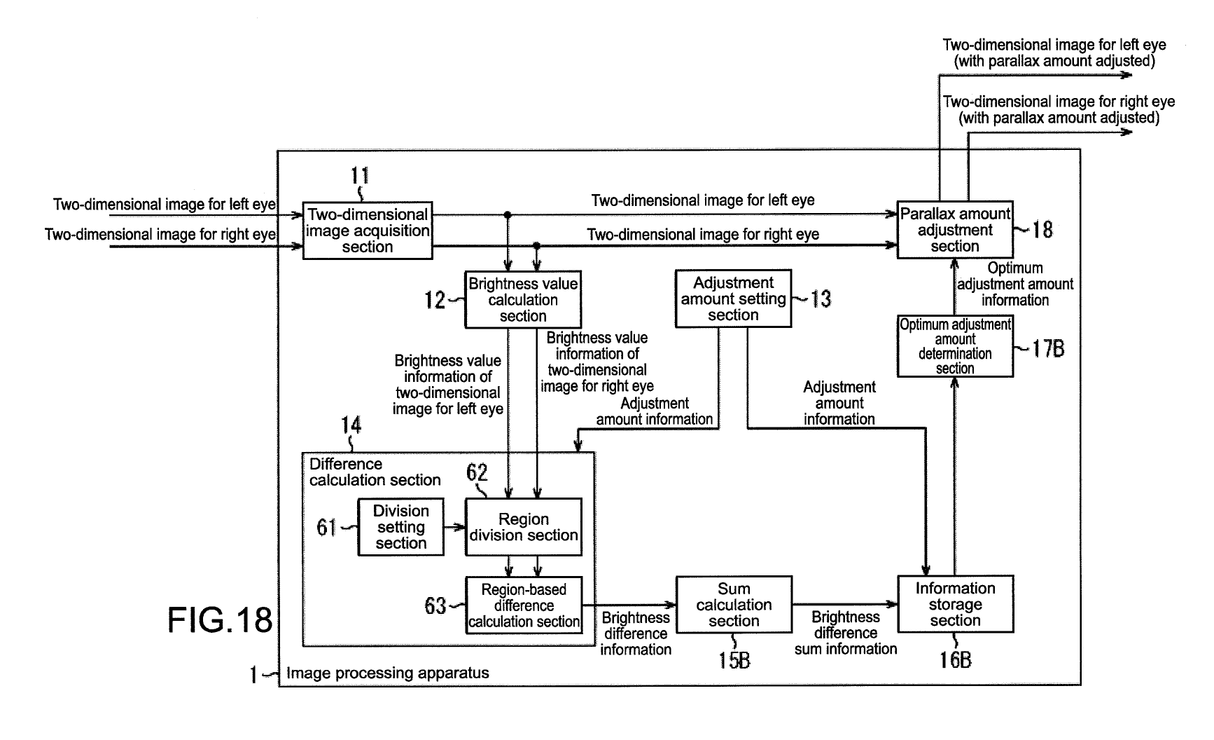

FIG. 18 shows a structural example of the image processing apparatus according to the fifth embodiment of the present invention.

In the first embodiment described above, the image processing apparatus 1 calculates the sum of the brightness differences for all pixels in the two-dimensional image for left eye and the two-dimensional image for right eye and determines the adjustment amount at which a sum of the brightness differences is smallest, as the optimum adjustment amount.

In contrast to this, in the fifth embodiment, the input two-dimensional image for left eye and two-dimensional image for right eye are divided into a plurality of regions, and a sum of brightness differences is calculated for each divided region. Then, an adjustment amount at which a sum of brightness differences is smallest is determined as an optimum adjustment amount for each divided region. Accordingly, it becomes possible to determine an optimum parallax amount in consideration of characteristics of the regions.

The image processing apparatus 1 of FIG. 18 is different from the image processing apparatus 1 of FIG. 6 in that a division setting section 61, a region division section 62, and a region-based difference calculation section 63 are provided as the difference calculation section 14. Moreover, in FIG. 18, the sum calculation section 15, the information storage section 16, and the optimum adjustment amount determination section 17 of FIG. 6 are replaced with a sum calculation section 15B, an information storage section 16B, and an optimum adjustment amount determination section 17B that correspond to a structure of the difference calculation section 14 of FIG. 18. Other structures are the same as those of the image processing apparatus 1 of FIG. 6. Descriptions on portions that are the same as those of the image processing apparatus 1 of FIG. 6 are omitted as appropriate.

The division setting section 61 sets a division number of the input two-dimensional image for left eye and two-dimensional image for right eye. For example, the division setting section 61 supplies a division number in each of a vertical direction and a horizontal direction of the images to the region division section 62, thus setting the division number.

The region division section 62 divides the entire region of each of the input two-dimensional image for left eye and the input two-dimensional image for right eye into the division number that has been set by the division setting section 61. The region division section 62 changes a parallax amount of the two-dimensional image for left eye and two-dimensional image for right eye by using the predetermined adjustment amount specified by the adjustment amount information.

The region-based difference calculation section 63 calculates (absolute values of) differences between brightness values of corresponding pixels in the two-dimensional image for left eye and the two-dimensional image for right eye on the basis of the divided regions. Then, the difference calculation section 14 supplies the differences between brightness values of pixels for each region to the sum calculation section 15B.

The sum calculation section 15B calculates a sum of the differences between brightness values regarding all the pixels on the basis of the divided regions. The sum of the brightness differences for each region is supplied, as brightness difference sum information, to the information storage section 16B. The information storage section 16B stores the predetermined adjustment amount represented by the adjustment amount information and the sum of the brightness differences for each region represented by the brightness difference sum information in association with each other. As a result, the information storage section 16B stores the adjustment amount and the sum of the brightness differences for each region in association with each other regarding all adjustment amounts that are set based on the adjustment range and the adjustment interval.

The optimum adjustment amount determination section 17B determines an optimum adjustment amount based on combinations of the adjustment amount and the sum of the brightness differences for each region that are stored in the information storage section 16B.

Here, how to determine an optimum adjustment amount is an important matter. That is, in each divided region, an adjustment amount at which a sum of brightness differences is smallest can be assumed to be an optimum adjustment amount. However, in a case where an adjustment amount at which a sum of brightness differences is smallest is determined as an optimum adjustment amount in each divided region but the adjustment amounts are different from one another among the respective divided region, a two-dimensional image for left eye and a two-dimensional image for right eye obtained after the adjustment are ruined.

In this regard, the optimum adjustment amount determination section 17B determines a common adjustment amount with respect to all the regions as an optimum adjustment amount according to a predetermined judging criterion.

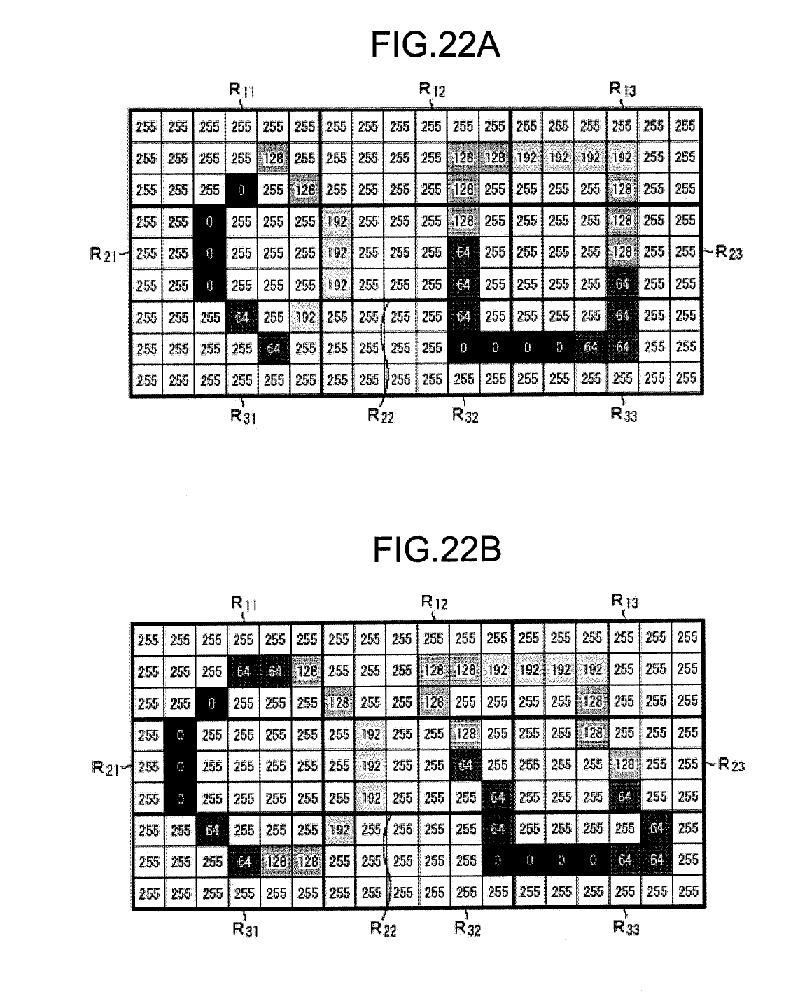

For example, the optimum adjustment amount determination section 17B determines, as the optimum adjustment amount, an adjustment amount at which the number of regions having a smallest sum of brightness differences is largest. This judging criterion is a first judging criterion. The determination of the optimum adjustment amount according to the first judging criterion will be described later with reference to FIGS. 22 to 28.

Further, the optimum adjustment amount determination section 17B determines, as the optimum adjustment amount, an adjustment amount at which a variance of the sums of brightness differences is smallest. This judging criterion is a second judging criterion.

When there is a region whose sum of brightness differences is extremely large, that portion is liable to be perceived as crosstalk. Therefore, the second judging criterion serves as a method of determining, as the optimum adjustment amount, an adjustment amount at which there is no region whose sum of brightness differences is extremely large.

Further, the optimum adjustment amount determination section 17B determines the optimum adjustment amount in consideration of a gaze region of the image. This judging criterion is a third judging criterion. Specifically, assuming that out of the nine divided regions, regions on the right-hand side of the image have an optimum adjustment amount of “−10” and those on the left-hand side of the image have an optimum adjustment amount of “+10”, in a case where a viewer gazes at the regions on the right-hand side of the image like a case where an object that attracts attention is present on the regions on the right-hand side of the image, the optimum adjustment amount determination section 17B determines the optimum adjustment amount of “−10” on the right-hand side as the optimum adjustment amount of the entire image. Further, in a case where a viewer gazes at the regions on the left-hand side of the image, the optimum adjustment amount determination section 17B determines the optimum adjustment amount of “+10” on the left-hand side as the optimum adjustment amount of the entire image.

It should be noted that the optimum adjustment amount determination section 17B may of course determine the optimum adjustment amount by a determination method other than the first to third judging criteria described above.

(Parallax Amount Adjustment Processing by Image Processing Apparatus 1 of FIG. 18)

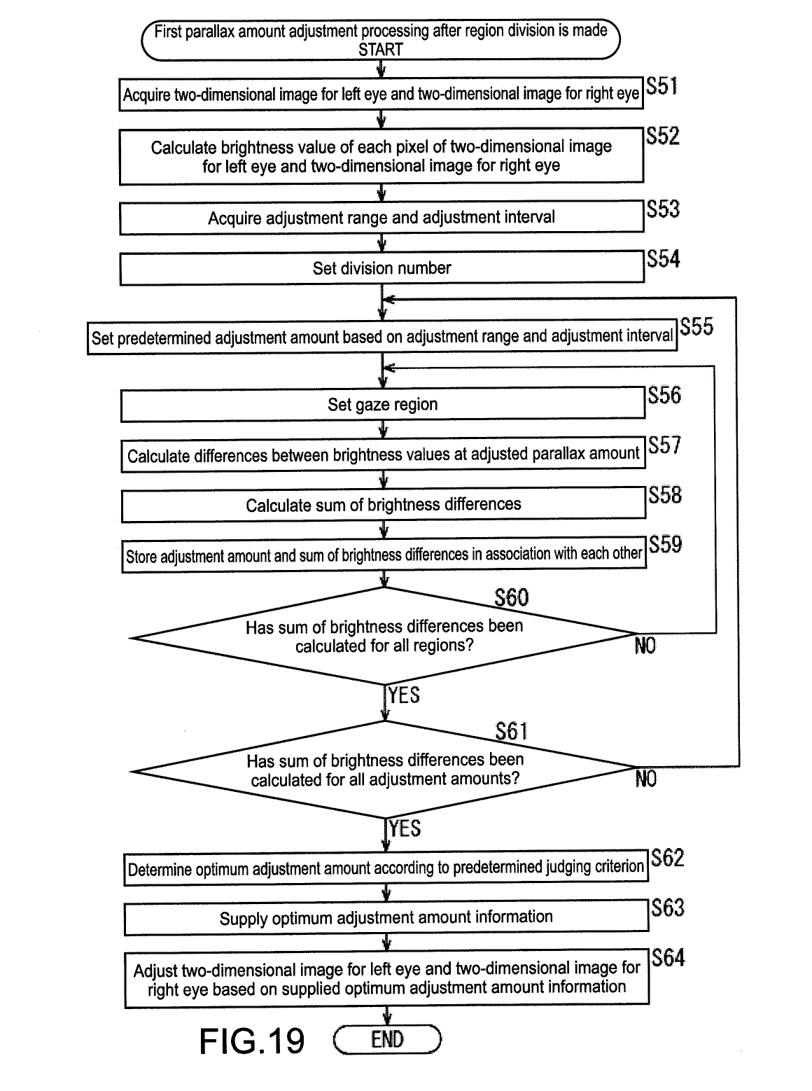

Next, with reference to a flowchart of FIG. 19, the first parallax amount adjustment processing that is executed by the image processing apparatus 1 of FIG. 18 after the region division has been made will be described.

Processing from Steps S51 to S53 of FIG. 19 are the same as those of Steps S1 to S3 of FIG. 7 described above and accordingly descriptions thereof will be omitted.

In Step S54, the division setting section 61 sets a division number of the input two-dimensional image for left eye and two-dimensional image for right eye. The region division section 62 divides the entire area of each of the two-dimensional image for left eye and two-dimensional image for right eye into the division number set by the division setting section 61.

In Step S55, the adjustment amount setting section 13 sets a predetermined adjustment amount based on the acquired adjustment range and adjustment interval and supplies the set adjustment amount to the difference calculation section 14 and the information storage section 16B as adjustment amount information. The region division section 62 of the difference calculation section 14 changes a parallax amount of the two-dimensional image for left eye and the two-dimensional image for right eye by using a predetermined adjustment amount specified by the adjustment amount information.

In Step S56, the region-based difference calculation section 63 sets a region to which attention is paid as a target subjected to the calculation of brightness differences (hereinafter, referred to as gaze region) out of the divided regions.

In Step S57, with respect the gaze region, the region-based difference calculation section 63 calculates (absolute values of) differences between brightness values of the two-dimensional image for left eye and two-dimensional image for right eye at a parallax amount obtained after the adjustment, and the calculation result is supplied to the sum calculation section 15B.

In Step S58, with respect the gaze region, the sum calculation section 15B calculates a sum of the brightness differences at the parallax amount obtained after the adjustment. The calculation result is supplied, as brightness difference sum information of the gaze region, from the sum calculation section 15B to the information storage section 16B.

In Step S59, the information storage section 16B stores the predetermined adjustment amount specified by the adjustment amount information and the sum of the brightness differences of the gaze region that is represented by the brightness difference sum information in association with each other.

In Step S60, the region-based difference calculation section 63 judges whether the sum of the brightness differences has been calculated for all the divided regions. In a case where it is judged in Step S60 that the sum of the brightness differences has not been calculated for all the divided regions, the processing returns to Step S56, and the processing from Steps S56 to S60 are repeated. In other words, a region where the sum of the brightness differences has not been calculated yet is set as a gaze region and the sum of the brightness differences at the predetermined adjustment amount is calculated.

On the other hand, in a case where it is judged in Step S60 that the sum of the brightness differences has been calculated for all the divided regions, the processing proceeds to Step S61.

In Step S61, the adjustment amount setting section 13 judges whether the sum of the brightness differences has been calculated for all the adjustment amounts. In a case where it is judged in Step S61 that the sum of the brightness differences has not been calculated for all the adjustment amounts, the processing returns to Step S55 and the processing from Steps S55 to S61 are repeated. In other words, an adjustment amount that has been not set yet is supplied, as the adjustment amount information, to the difference calculation section 14 and the information storage section 16B, and the sum of the brightness differences for each region at the predetermined adjustment amount is calculated.

On the other hand, in a case where it is judged in Step S61 that the sum of the brightness differences has been calculated for all the adjustment amounts, the processing proceeds to Step S62.

In Step S62, the optimum adjustment amount determination section 17B determines an optimum adjustment amount according to the predetermined judging criterion. For example, when adopting the first judging criterion, the optimum adjustment amount determination section 17B determines, as the optimum adjustment amount, an adjustment amount at which the number of regions having a smallest sum of brightness differences is largest. Further, when adopting the second judging criterion, the optimum adjustment amount determination section 17B determines, as the optimum adjustment amount, an adjustment amount at which a variance in the sums of brightness differences is smallest.

In Step S63, the optimum adjustment amount determination section 17B supplies the determined optimum adjustment amount, as the optimum adjustment amount information, to the parallax amount adjustment section 18.

In Step S64, the parallax amount adjustment section 18 adjusts the input two-dimensional image for left eye and two-dimensional image for right eye based on the supplied optimum adjustment amount information, outputs the two-dimensional image for left eye and two-dimensional image for right eye that have been subjected to the adjustment, and terminates the processing.

As described above, by judging the optimum adjustment amount based on the sum of the brightness differences for each divided region, it is possible to determine an optimum adjustment amount for the entire input two-dimensional image for left eye and two-dimensional image for right eye.

### 6. Sixth Embodiment

Though the processing of FIG. 19 is an example in which the first parallax amount adjustment processing described with reference to FIG. 7 is performed for each divided region, the second parallax amount adjustment processing described with reference to FIG. 9 can also be performed for each divided region.

In a case where the second parallax amount adjustment processing is performed for each divided region, a change in structure from the image processing apparatus 1 of FIG. 6 to the image processing apparatus 1 of FIG. 18 only needs to be similarly applied to the image processing apparatus 1 of FIG. 8. That is, the difference calculation section 14 of the image processing apparatus of FIG. 8 includes the division setting section 61, the region division section 62, and the region-based difference calculation section 63 and also includes the number-of-pixels count section 32, the information storage section 16B, and the optimum adjustment amount determination section 17B corresponding thereto.

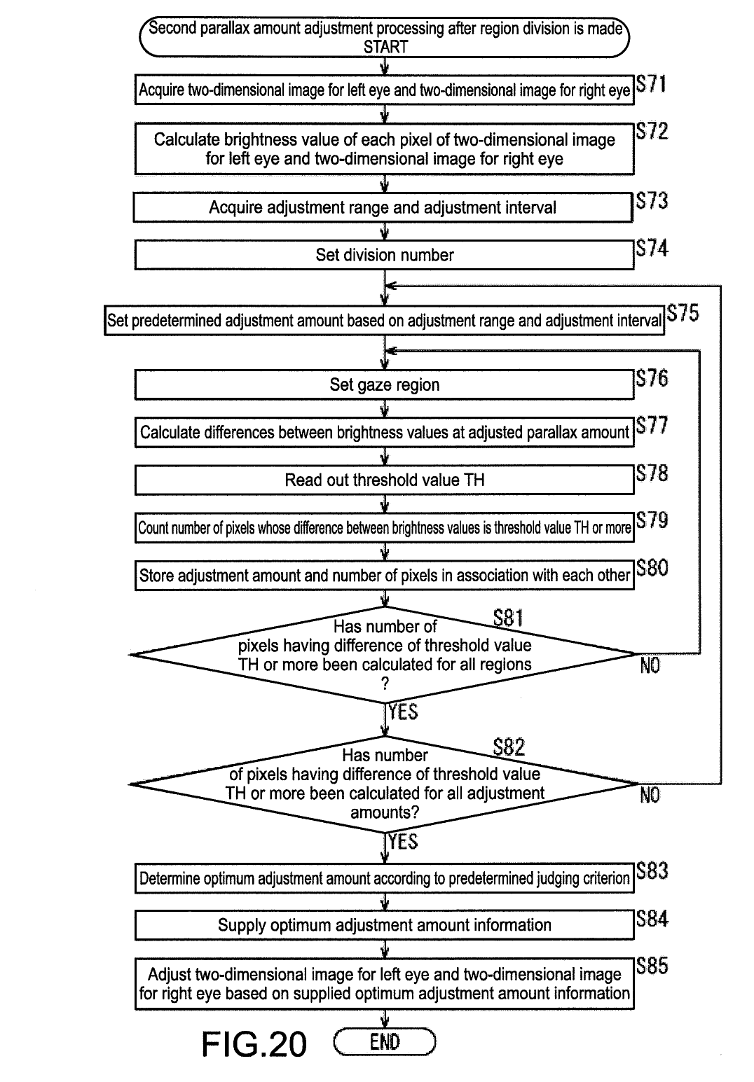

FIG. 20 is a flowchart showing processing in a case where the second parallax amount adjustment processing is performed for each divided region.

Steps S71 to S77 of FIG. 20 are the same as Steps S51 to S57 of FIG. 19 described above and accordingly descriptions thereof will be omitted.

In Step S78, the number-of-pixels count section 32 reads out a threshold value TH stored in the threshold value storage section 31. Then, in Step S79, the number-of-pixels count section 32 compares a difference between brightness values with the threshold value TH for each pixel in the gaze region, and counts the number of pixels having a difference between brightness values that is equal to or larger than the threshold value TH.

In Step S80, the information storage section 16B stores the adjustment amount represented by the adjustment amount information supplied from the adjustment amount setting section 13 and the number of pixels in the gaze region that is represented by the number-of-pixels count information supplied from the number-of-pixels count section 32 in association with each other.

In Step S81, the region-based difference calculation section 63 judges whether the number of pixels having a difference equal to or larger than the threshold value TH has been calculated for all the divided regions. When it is judged in Step S81 that the number of pixels having a difference equal to or larger than the threshold value TH has been not calculated for all the divided regions, the processing returns to Step S76 and the processing from Steps S76 to S81 are repeated. In other words, a region where the number of pixels having a difference equal to or larger than the threshold value TH has not been calculated yet is set as the gaze region and the number of pixels at the predetermined adjustment amount is calculated.

On the other hand, when it is judged in Step S81 that the number of pixels having a difference equal to or larger than the threshold value TH has been calculated for all the divided regions, the processing proceeds to Step S82.

In Step S82, the adjustment amount setting section 13 judges whether the number of pixels having a difference equal to or larger than the threshold value TH has been calculated for all the adjustment amounts specified based on the adjustment range and adjustment interval. When it is judged in Step S82 that the number of pixels having a difference equal to or larger than the threshold value TH has not been calculated for all the adjustment amounts, the processing returns to Step S75 and the processing from Steps S75 to S82 are repeated. In other words, an adjustment amount that has not been set yet is supplied, as the adjustment amount information, to the difference calculation section 14 and the information storage section 16B and the number of pixels having a difference equal to or larger than the threshold value TH at the predetermined adjustment amount is calculated.

On the other hand, when it is judged in Step S82 that the number of pixels having a difference equal to or larger than the threshold value TH has been calculated for all the adjustment amounts, the processing proceeds to Step S83.

In Step S83, the optimum adjustment amount determination section 17B determines an optimum adjustment amount according to the predetermined judging criterion. For example, when adopting the first judging criterion, the optimum adjustment amount determination section 17B determines, as the optimum adjustment amount, an adjustment amount at which the number of regions where the number of pixels having a difference equal to or larger than the threshold value TH is smallest is largest.

In Step S84, the optimum adjustment amount determination section 17B supplies the determined optimum adjustment amount to the parallax amount adjustment section 18 as optimum adjustment amount information.

In Step S85, the parallax amount adjustment section 18 adjusts the input two-dimensional image for left eye and two-dimensional image for right eye based on the supplied optimum adjustment amount information, outputs the two-dimensional image for left eye and two-dimensional image for right eye that have been subjected to the adjustment, and terminates the processing.

As described above, by judging the optimum adjustment amount based on the number of pixels having a difference equal to or larger than the threshold value TH for each divided region, it is possible to determine an optimum adjustment amount for the entire input two-dimensional image for left eye and two-dimensional image for right eye.

(Numerical Example of First Parallax Amount Adjustment Processing and Second Parallax Amount Adjustment Processing Performed after Region Division has been Made)

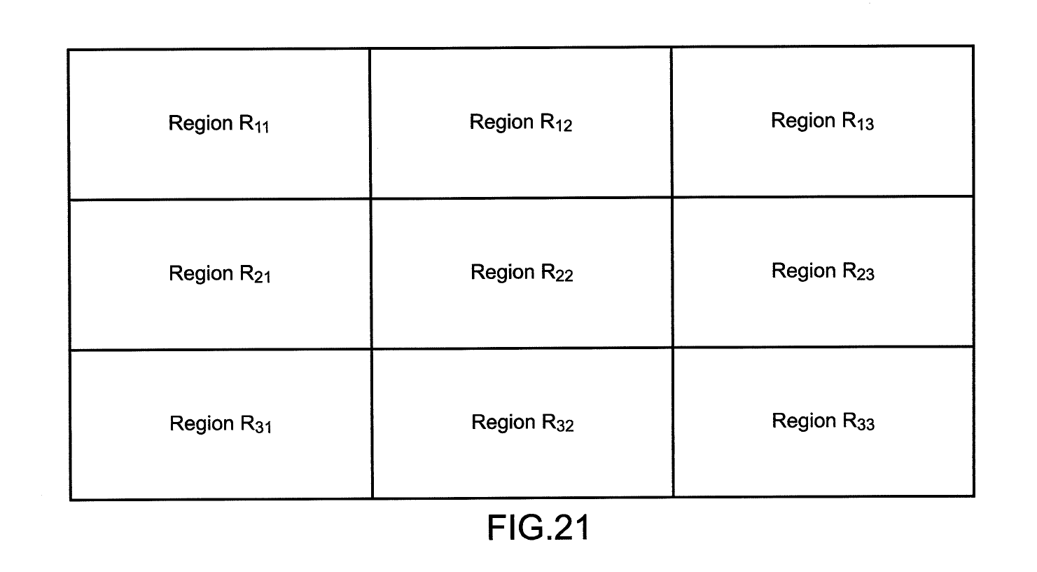

Next, with reference to FIGS. 21 to 28, the first parallax amount adjustment processing performed after the region division has been made and the second parallax amount adjustment processing performed after the region division has been made will be further described. It should be noted that in this example, the first judging criterion is used as a judging criterion.

The division setting section 61 divides each of the two-dimensional image for left eye and the two-dimensional image for right eye, each having 162 pixels formed of 18 pixels arranged in a horizontal direction and 9 pixels arranged in a vertical direction, into three in each of vertical and horizontal directions. As a result, as shown in FIG. 21, the two-dimensional image for left eye and the two-dimensional image for right eye are each divided into nine regions of a region R₁₁, a region R₁₂, a region R₁₃, a region R₂₁, a region R₂₂, a region R₂₃, a region R₃₁, a region R₃₂, and a region R₃₃.

FIG. 22A is an example of nine divided regions corresponding to FIG. 10A. That is, FIG. 22A shows the two-dimensional image for left eye of FIG. 10A divided into the nine regions R₁₁ to R₃₃.

FIG. 22B is an example of nine divided regions corresponding to FIG. 10B. That is, FIG. 22B shows the two-dimensional image for right eye of FIG. 10B divided into the nine regions R₁₁ to R₃₃.

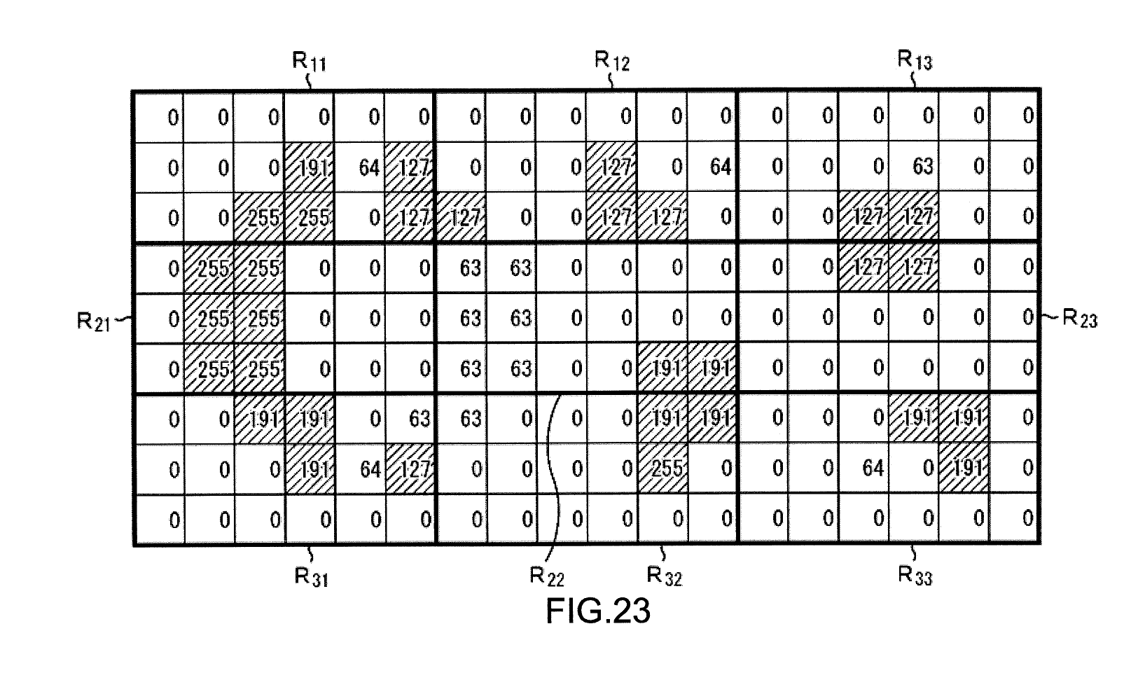

FIG. 23 is an example of nine divided regions corresponding to FIG. 11. That is, FIG. 23 shows an example in which differences between brightness values in the two-dimensional image for left eye of FIG. 10A and the two-dimensional image for right eye of FIG. 10B, the differences being obtained when the adjustment amount is “0”, are divided into nine regions.

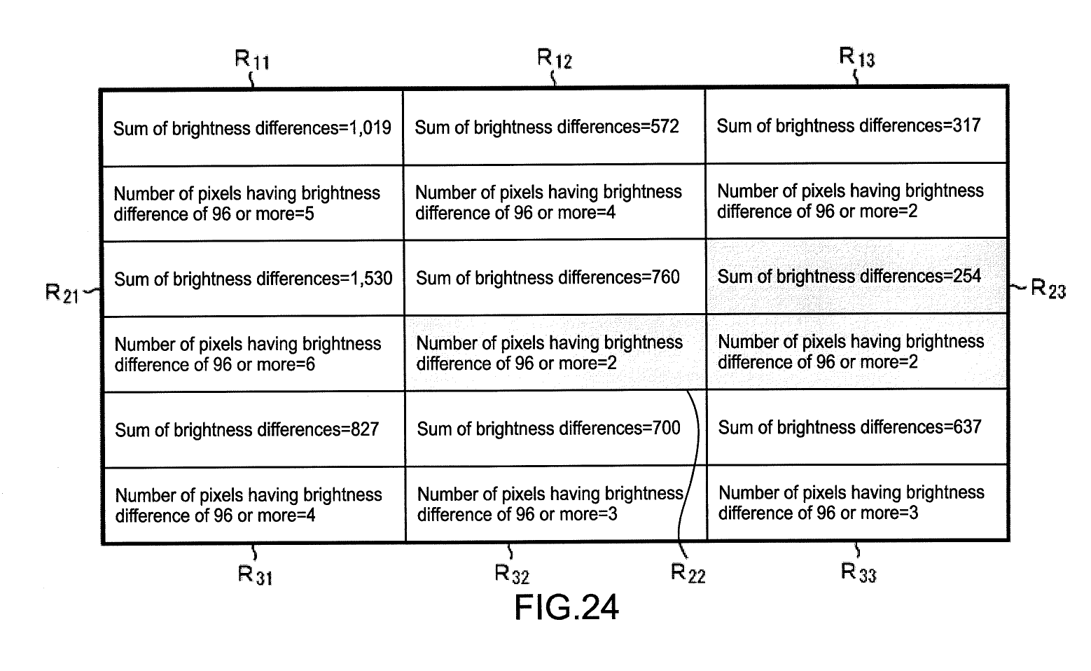

FIG. 24 shows calculation results obtained by calculating a sum of the brightness differences and the number of pixels having a difference equal to or larger than a threshold value TH in each region, with respect to the differences between the brightness values of pixels in the regions R₁₁ to R₃₃, obtained at the adjustment amount of “0” in FIG. 23. It should be noted that the threshold value TH is “96” that is the same as in the above example.

In FIG. 24, the calculation results of a sum of brightness differences between pixels in a region, the sum being calculated in the first parallax amount adjustment processing, and the number of pixels having a difference equal to or larger than the threshold value TH of “96” in the region, the number of pixels being calculated in the second parallax amount adjustment processing, are shown in the upper line and the lower line of each region, respectively. That is, the upper line of each of the regions R₁₁ to R₃₃ is a sum of brightness differences between pixels calculated in the first parallax amount adjustment processing, and the lower line thereof is the number of pixels having a difference equal to or larger than the threshold value TH, calculated in the second parallax amount adjustment processing.

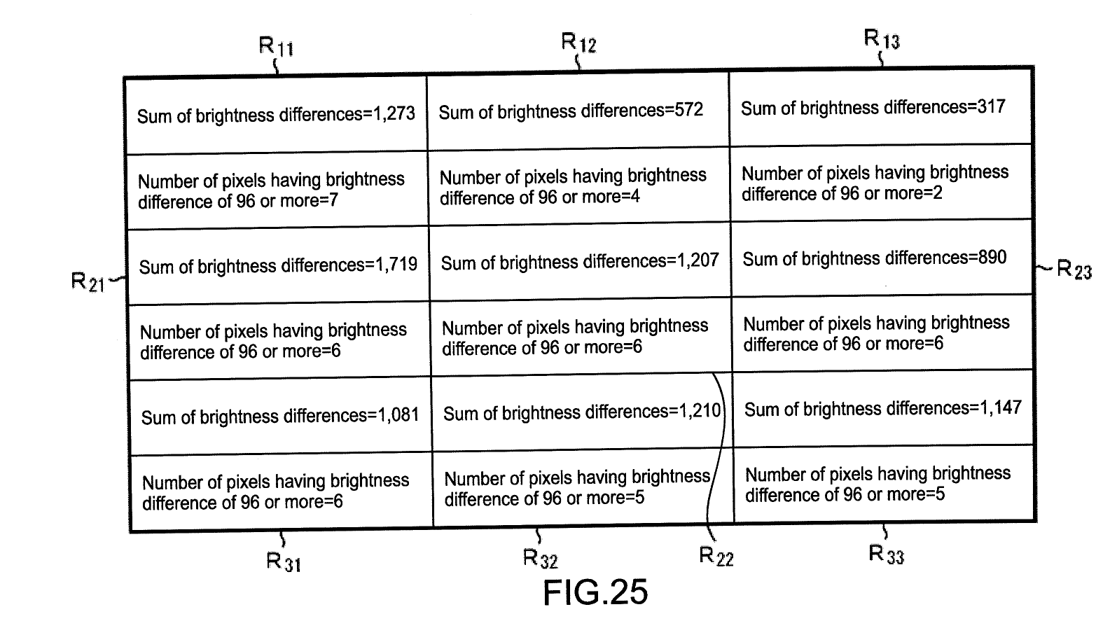

FIG. 25 shows calculation results obtained by dividing FIG. 12 showing the differences between the brightness values of pixels at the adjustment amount of “−2” into the regions R₁₁ to R₃₃, and calculating a sum of the brightness differences and the number of pixels having a difference equal to or larger than the threshold value TH in each region.

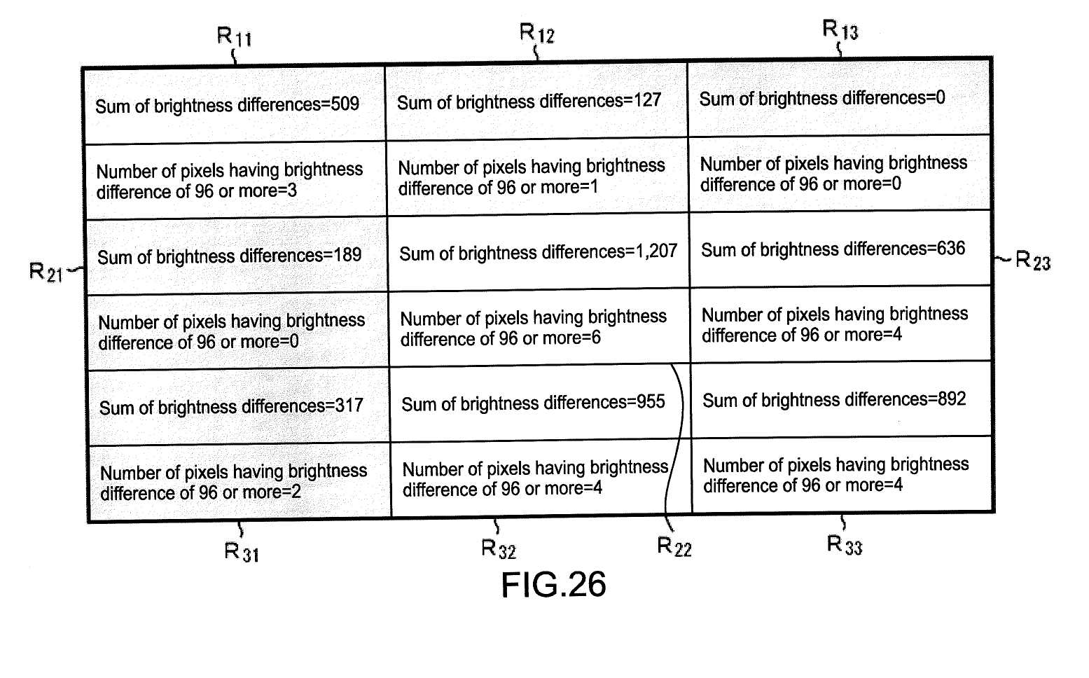

FIG. 26 shows calculation results obtained by dividing FIG. 13 showing the differences between the brightness values of pixels at the adjustment amount of “−1” into the regions R₁₁ to R₃₃, and calculating a sum of the brightness differences and the number of pixels having a difference equal to or larger than the threshold value TH in each region.

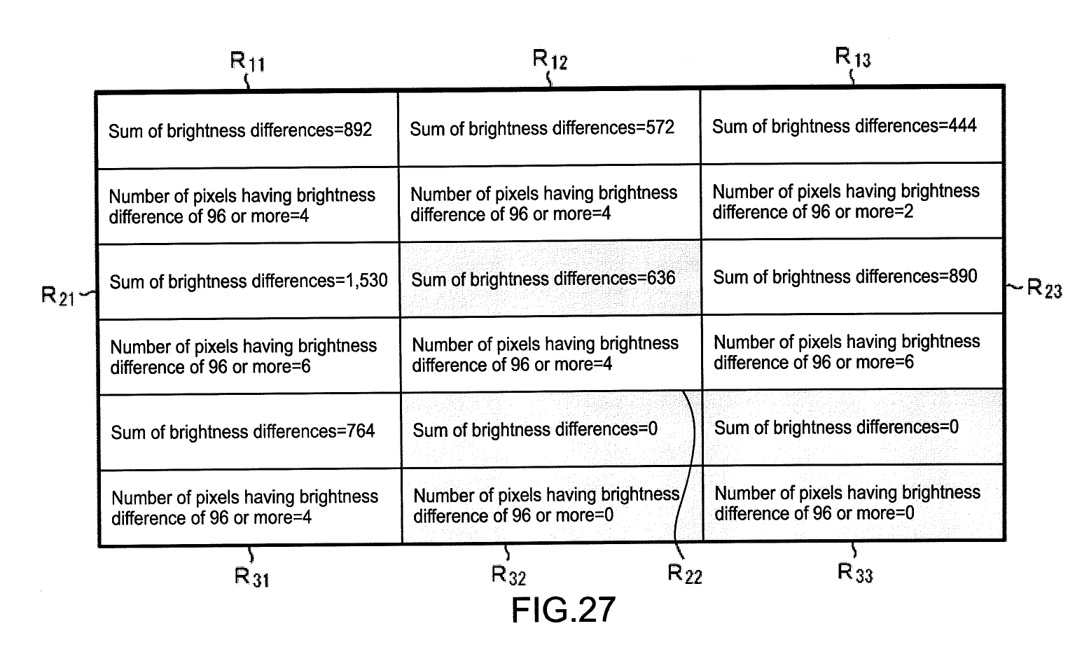

FIG. 27 shows calculation results obtained by dividing FIG. 14 showing the differences between the brightness values of pixels at the adjustment amount of “+1” into the regions R₁₁ to R₃₃, and calculating a sum of the brightness differences and the number of pixels having a difference equal to or larger than the threshold value TH in each region.

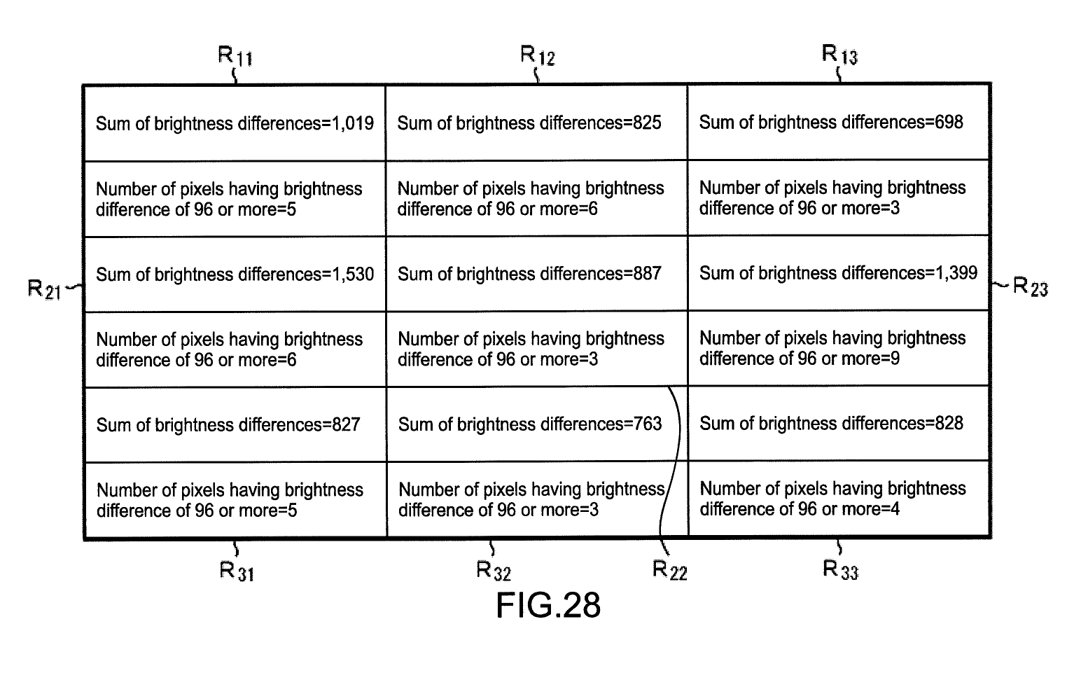

FIG. 28 shows calculation results obtained by dividing FIG. 15 showing the differences between the brightness values of pixels at the adjustment amount of “+2” into the regions R₁₁ to R₃₃, and calculating a sum of the brightness differences and the number of pixels having a difference equal to or larger than the threshold value TH in each region.

In the first parallax amount adjustment processing performed after the region division has been made, the sum of brightness differences shown in the upper line of each region in FIGS. 24 to 28 is associated with the adjustment amount and stored in the information storage section 16B.

On the other hand, in the second parallax amount adjustment processing performed after the region division has been made, the number of pixels having a difference equal to or larger than the threshold value TH shown in the lower line of each region in FIGS. 24 to 28 is associated with the adjustment amount and stored in the information storage section 16B.

With respect to such calculation results, the optimum adjustment amount determination section 17B determines an optimum adjustment amount according to the first judging criterion.

When the optimum adjustment amount is determined in the first parallax amount adjustment processing performed after the region division has been made, the optimum adjustment amount determination section 17B determines, as the optimum adjustment amount, an adjustment amount at which the number of regions having a smallest sum of brightness differences is largest.

Out of the sums of brightness differences in the upper lines of the regions in FIGS. 24 to 28, a region with an adjustment amount at which the sum of brightness differences is smallest among the five adjustment amounts is shaded with gray color.

That is, when the adjustment amount is “−1” in FIG. 26, the regions R₁₁, R₁₂, R₁₃, R₂₁, and R₃₁ have the smallest sum of brightness differences among the five adjustment amounts. When the adjustment amount is “+1” in FIG. 27, the regions R₂₂, R₃₂, and R₃₃ have the smallest sum of brightness differences among the five adjustment amounts. When the adjustment amount is “0” in FIG. 24, the regions R₂₃ has the smallest sum of brightness differences among the five adjustment amounts.

So, among the five adjustment amounts, an adjustment amount at which the number of regions having the smallest sum of brightness differences is largest is the adjustment amount of “−1” of FIG. 26 having five regions. Accordingly, the adjustment amount of “−1” is determined as the optimum adjustment amount by the optimum adjustment amount determination section 17B.

On the other hand, when the optimum adjustment amount is determined in the second parallax amount adjustment processing performed after the region division has been made, the optimum adjustment amount determination section 17B determines, as the optimum adjustment amount, an adjustment amount at which the number of regions where the number of pixels having a difference equal to or larger than the threshold value TH is smallest is largest.

Out of the numbers of pixels having a difference equal to or larger than the threshold value TH in the lower lines of the regions in FIGS. 24 to 28, a region with an adjustment amount at which the number of pixels having a difference equal to or larger than the threshold value TH is smallest among the five adjustment amounts is shaded with gray color.

That is, when the adjustment amount is “−1” in FIG. 26, the regions R₁₁, R₁₂, R₁₃, R₂₁, and R₃₁ have the smallest number of pixels among the five adjustment amounts. When the adjustment amount is “+1” in FIG. 27, the regions R₃₂ and R₃₃ have the smallest number of pixels among the five adjustment amounts. When the adjustment amount is “0” in FIG. 24, the regions R₂₂ and R₂₃ have the smallest number of pixels among the five adjustment amounts.

So, among the five adjustment amounts, an adjustment amount at which the number of regions having the smallest number of pixels is largest is the adjustment amount of “−1” having five regions. Accordingly, the adjustment amount of “−1” is determined as the optimum adjustment amount by the optimum adjustment amount determination section 17B.

It should be noted that in a case where there is a gaze region at which a viewer gazes in the divided regions, the sum of brightness differences or the number of pixels may be multiplied by a weighting factor in accordance with a degree of gaze in each region, for example. When a region where the sum of brightness differences or the number of pixels is smallest is determined by using the weighted sum of brightness differences or number of pixels, priority can be given to an adjustment amount of the region at which the viewer gazes as in the third judging criterion.

As described above, by judging the optimum adjustment amount based on the sum of brightness differences or the number of pixels having a difference between brightness values that is equal to or larger than the threshold value TH for each divided region, it is possible to determine an optimum adjustment amount for the entire input two-dimensional image for left eye and two-dimensional image for right eye. Accordingly, it is possible to display a three-dimensional image in which crosstalk is reduced more in consideration of characteristics of the regions or a situation of a viewer.

### 7. Seventh Embodiment

Next, an image processing apparatus according to a seventh embodiment will be described.

(Structural Example of Image Processing Apparatus)

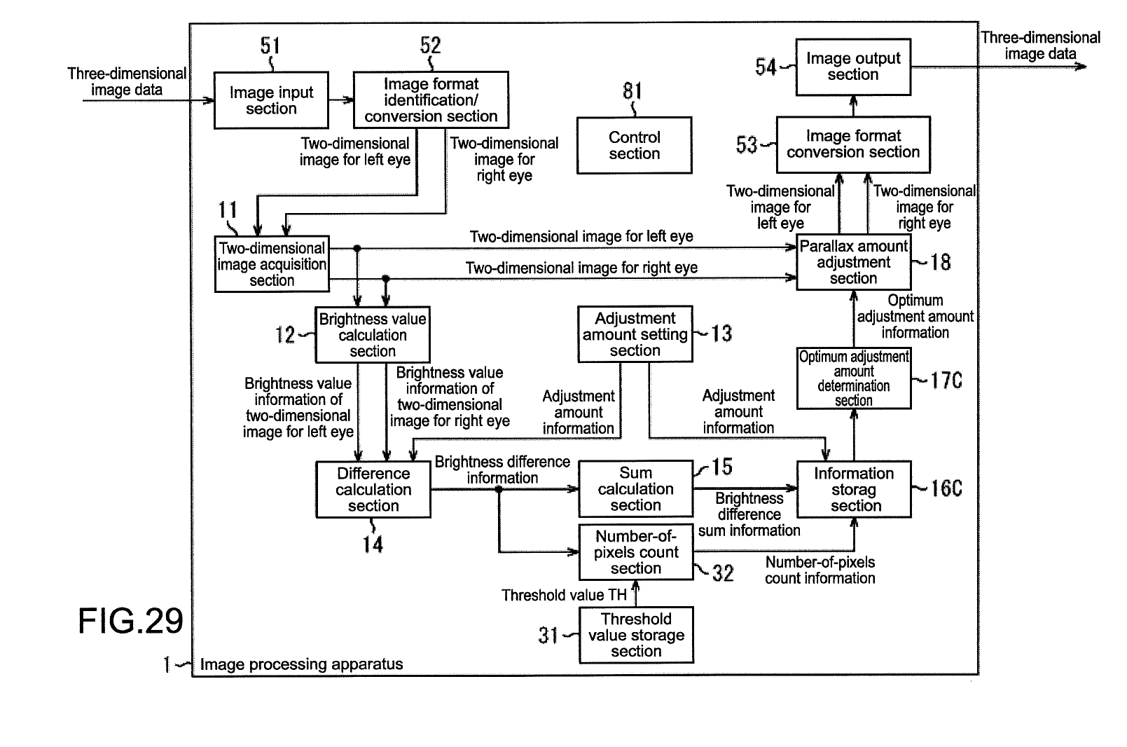

FIG. 29 shows a structural example of the image processing apparatus according to the seventh embodiment of the present invention.

An image processing apparatus 1 of FIG. 29 includes all the structures of FIGS. 16 and 18 that do not overlap one another, and further includes a control section 81. Here, an information storage section 16C has both the functions of the information storage section 16 of the first embodiment and the information storage section 16A of the second embodiment. Similarly, an optimum adjustment amount determination section 17C has both the functions of the optimum adjustment amount determination section 17 of the first embodiment and the optimum adjustment amount determination section 17A of the second embodiment.

The image processing apparatus 1 of FIG. 29 can execute the first parallax amount adjustment processing and the second parallax amount adjustment processing selectively.

In other words, the control section 81 determines which of the first parallax amount adjustment processing and the second parallax amount adjustment processing is executed, and controls the respective sections in accordance with that determination.

The difference calculation section 14 supplies (absolute values of) the calculated differences between brightness values to the sum calculation section 15 and the number-of-pixels count section 32.

In a case where the control section 81 selects the first parallax amount adjustment processing to be executed, the sum calculation section 15 calculates a sum of brightness differences based on the differences between brightness values at a predetermined adjustment amount, the differences between brightness values being supplied from the difference calculation section 14. Then, the sum calculation section 15 supplies the calculation result to the information storage section 16C, as brightness difference sum information.

On the other hand, in a case where the control section 81 selects the second parallax amount adjustment processing to be executed, the number-of-pixels count section 32 counts the number of pixels having a difference between brightness values that is equal to or larger than the threshold value TH, based on the differences between brightness values of pixels at a predetermined adjustment amount, the differences being supplied from the difference calculation section 14. Then, the number-of-pixels count section 32 supplies the counted number of pixels to the information storage section 16C, as number-of-pixels count information.

The information storage section 16C stores the adjustment amount and the sum of brightness differences in association with each other in the first parallax amount adjustment processing, and stores the adjustment amount and the number of pixels in association with each other in the second parallax amount adjustment processing.

The optimum adjustment amount determination section 17C determines, as the optimum adjustment amount, the adjustment amount at which the sum of brightness differences is smallest in the first parallax amount adjustment processing, and determines, as the optimum adjustment amount, the adjustment amount at which the number of pixels is smallest in the second parallax amount adjustment processing.

It should be noted that the control section 81 may execute both the first parallax amount adjustment processing and the second parallax amount adjustment processing and select an optimum adjustment amount due to any of the first and second parallax amount adjustment processing.

Further, in addition to selecting the first parallax amount adjustment processing or the second parallax amount adjustment processing to be executed, the control section 81 can control a change of the optimum adjustment amount depending on specifications of an input three-dimensional image. Here, specifically, the specifications of the three-dimensional image represent “type of three-dimensional images” classified into “natural image”, “computer graphics”, “animation”, “movie”, and the like, “characteristics of three-dimensional image” such as distribution of spatial frequency, distribution of color and brightness, and contrast between background and objects, and the like.

For example, in a case where the type of an input three-dimensional image is “movie” in which a video having an impact on viewers is intended to be presented, the control section 81 can make a setting in which much importance is put on an impact as a three-dimensional image even if crosstalk is perceived in some degree. That is, the control section 81 can cause the parallax amount adjustment section 18 to change the optimum adjustment amount such that a parallax amount becomes larger than the determined optimum adjustment amount in the entire image.

Further, for example, in a case where the input three-dimensional image has characteristics in which contrast is small in adjacent portions of the background and objects, crosstalk is hard to be perceived in those adjacent portions. In such a case, the control section 81 can cause the parallax amount adjustment section 18 to change the optimum adjustment amount such that a parallax amount becomes larger than the determined optimum adjustment amount in the entire image. As described above, in the image processing apparatus 1 of FIG. 29, it is possible to emphasize an effect as a three-dimensional image in accordance with the specifications of the three-dimensional image.

Moreover, the control section 81 can also control a change of the optimum adjustment amount depending on specifications of a display apparatus that is an output destination of the image output section 54. Here, specifically, the specifications of the display apparatus represent a contrast ratio or a brightness value that can be displayed by the display apparatus, specifications of a display device, and the like.

For example, it is assumed that the control section 81 can acquire a contrast ratio as a specification of the display apparatus serving as an output destination of the image output section 54. Generally, crosstalk is liable to be perceived when a region of high brightness and a region of low brightness are adjacent to each other. So, assuming that crosstalk is hard to be perceived in a case where the acquired contrast ratio of the display apparatus is equal to or smaller than a predetermined value, the control section 81 can make a setting in which much importance is put on an impact of a three-dimensional image on a viewer. In other words, the control section 81 can cause the parallax amount adjustment section 18 to change the optimum adjustment amount such that a parallax amount becomes larger than the determined optimum adjustment amount in the entire image.

For example, it is assumed that as a display apparatus to be connected, there are a liquid crystal display having a contrast ratio of 3,000:1 and an organic EL display having a contrast ratio of 1,000,000:1.

In a case where the organic EL display is connected as the display apparatus and a high contrast ratio is acquired, the control section 81 generates a two-dimensional image for left eye and a two-dimensional image for right eye by using an optimum adjustment amount determined in the first or second parallax amount adjustment processing. On the other hand, in a case where the liquid crystal display is connected, the control section 81 causes the parallax amount adjustment section 18 to change the optimum adjustment amount such that a parallax amount becomes larger than the determined optimum adjustment amount in the entire image. In this manner, in the image processing apparatus 1 of FIG. 29, it is possible to emphasize an effect as a three-dimensional image in accordance with the specifications of the display apparatus.

As described above, the image processing apparatus 1 of FIG. 29 can display a three-dimensional image by using an optimum adjustment amount with which crosstalk is suppressed and also display a three-dimensional image in which an effect as a three-dimensional image is emphasized in accordance with specifications of the three-dimensional image or specifications of a display apparatus. It should be noted that the specifications of the three-dimensional image or the specifications of a display apparatus may be input by a viewer or may be acquired as control information from the display apparatus itself.

According to the image processing apparatus 1 of each of the first to seventh embodiments described above, a calculation amount using differences between brightness value of corresponding pixels in the two-dimensional image for left eye and the two-dimensional image for right eye in which the parallax amount has been adjusted (sum of brightness differences or number of pixels having a difference of threshold value TH or more) is calculated. Then, by determining an adjustment amount at which the calculation amount becomes smallest, an optimum adjustment amount is determined and a parallax amount of the input two-dimensional image for left eye and two-dimensional image for right eye is adjusted. Accordingly, it is possible to display a three-dimensional image in which crosstalk is reduced more. In addition, it is unnecessary for a viewer to perform an operation by him/herself, such as adjusting the parallax amount so that crosstalk is reduced, with the result that operability of a user is improved.

### 8. Eighth Embodiment

The above example has described that the image processing apparatus 1 generates three-dimensional image data with reduced crosstalk and outputs it to a display apparatus or the like that is connected at a subsequent stage. However, the image processing apparatus 1 may be incorporated into the display apparatus as a part thereof.

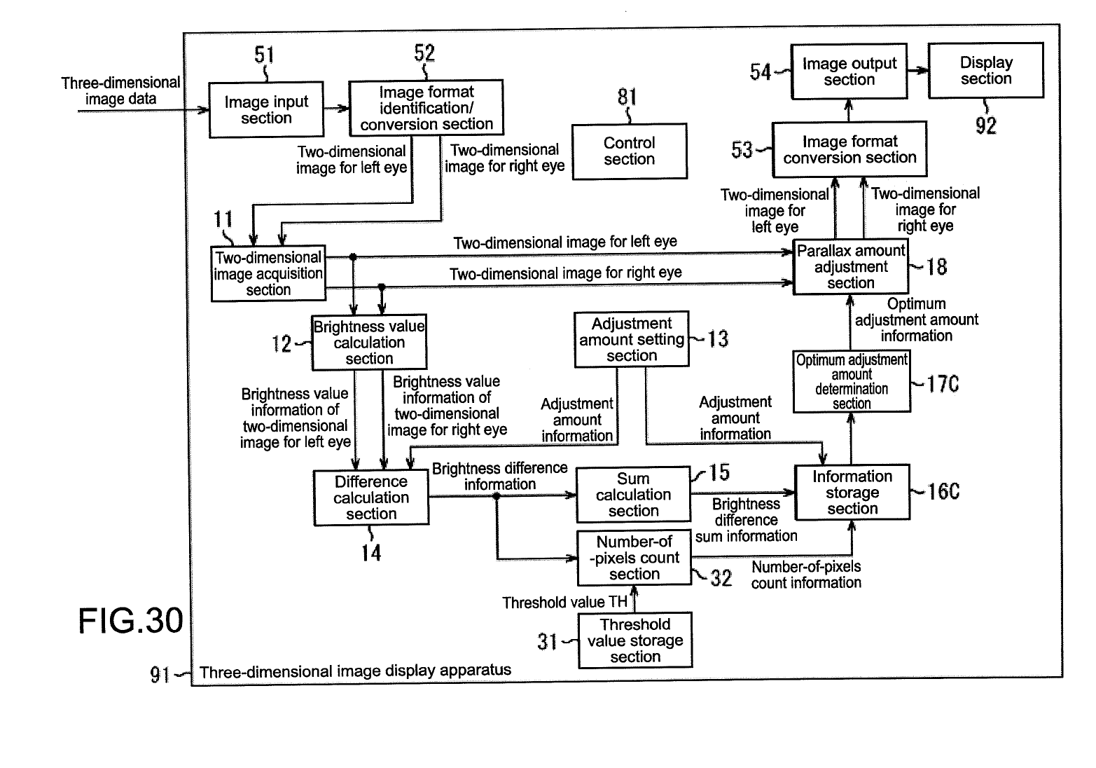

FIG. 30 shows a structural example of a display apparatus into which the image processing apparatus 1 of the seventh embodiment described above is incorporated.

A three-dimensional image display apparatus 91 of FIG. 30 includes a display section 92 in addition to the structure of the image processing apparatus 1 of FIG. 29.

The display section 92 is constituted of, for example, an organic EL panel or a liquid crystal panel, and displays the two-dimensional image for left eye and the two-dimensional image for right eye based on the three-dimensional image data supplied from the image output section 54.

With this structure, the three-dimensional image display apparatus 91 can display a three-dimensional image in which crosstalk is reduced more.

A series of processing described above may be executed by hardware or software. In a case where the series of processing is executed by software, a program constituting that software is installed in a computer.

Here, examples of the computer include a computer incorporated into dedicated hardware and a general-purpose personal computer capable of executing various types of functions by installing various types of programs.

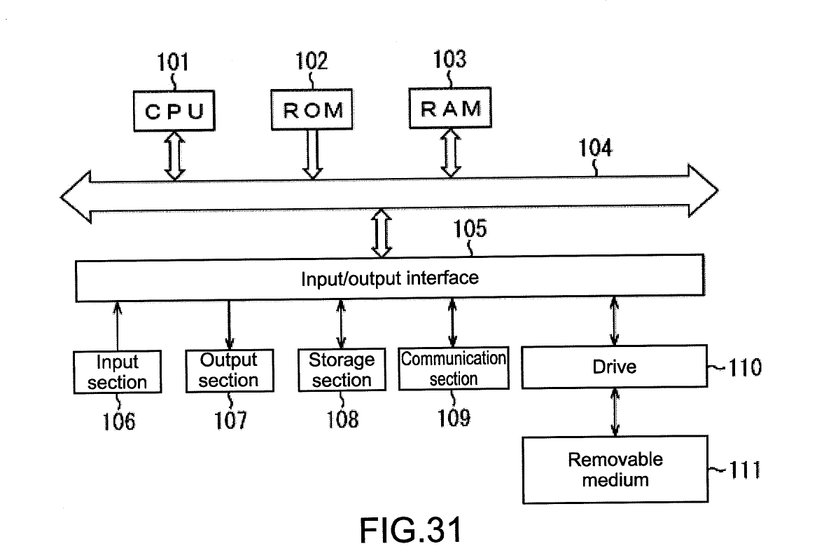

FIG. 31 is a block diagram showing a structural example of hardware of a computer that executes the series of processing described above by a program.

In the computer, a CPU (Central Processing Unit) 101, a ROM (Read Only Memory) 102, and a RAM (Random Access Memory) 103 are connected to each other via a bus 104.

Further, an input/output interface 105 is connected to the bus 104. To the input/output interface 105, an input section 106, an output section 107, a storage section 108, a communication section 109, and a drive 110 are connected.

The input section 106 is constituted of a keyboard, a mouse, a microphone, or the like. The output section 107 is constituted of a display, a speaker, or the like. The storage section 108 is constituted of a hard disc, a nonvolatile memory, or the like. The communication section 109 is constituted of a network interface or the like. The drive 110 drives a removable medium 111 such as a magnetic disc, an optical disc, a magnet-optical disc, and a semiconductor memory.

In the computer constituted as described above, for example, the CPU 101 loads a program stored in the storage section 108 via the input/output interface 105 and the bus 104 to the RAM 103 and executes it, and thus the series of processing described above is performed.

The program executed by the computer (CPU 101) can be recorded in the removable medium 111 as a packaged medium or the like and thus provided, for example. Further, the program can be provided via a wireless or wired transmission medium such as a local area network, the Internet, and digital broadcasting.

In the computer, the program can be installed in the storage section 108 via the input/output interface 105 by mounting the removable medium 111 to the drive 110. Further, the program can be installed in the storage section 108 by being received in the communication section 109 via a wireless or wired transmission medium. Furthermore, the program can be installed in the ROM 102 or the storage section 108 in advance.

It should be noted that the program executed by the computer may be a program by which processing is performed in chronological order along the order described herein, or may be a program by which processing is performed in parallel or at a necessary timing when a calling is made or the like.

The present application contains subject matter related to that disclosed in Japanese Priority Patent Application JP 2009-045284 filed in the Japan Patent Office on Feb. 27, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus, comprising:
an adjustment amount setting means for setting an adjustment amount of a parallax amount with respect to a two-dimensional image for left eye and a two-dimensional image for right eye;
a difference calculation means for calculating a difference between brightness values of the two-dimensional image for left eye and the two-dimensional image for right eye in which the parallax amount is changed using the adjustment amount set by the adjustment amount setting means;
a smallest value judgment means for determining an optimum adjustment amount by judging the adjustment amount at which a calculation amount using the difference between brightness values is smallest; and
a parallax amount adjustment means for adjusting the parallax amount of the two-dimensional image for left eye and the two-dimensional image for right eye, based on the optimum adjustment amount determined by the smallest value judgment means.

2. The image processing apparatus according to claim 1,
wherein the calculation amount using the difference between brightness values is one of a sum and a variance of the differences between brightness values, and
wherein the smallest value judgment means includes
a sum calculation means for calculating the sum of the differences between brightness values, and
an optimum adjustment amount determination means for determining, as the optimum adjustment amount, the adjustment amount at which one of the sum and the variance of the differences between brightness values is smallest, out of the parallax amounts plurally set by the parallax amount adjustment means.

3. The image processing apparatus according to claim 2, further comprising
a region division means for dividing the two-dimensional image for left eye and the two-dimensional image for right eye into a plurality of regions,
wherein the smallest value judgment means determines the optimum adjustment amount by judging the adjustment amount at which one of the sum and the variance of the differences between brightness values is smallest for each of the divided regions.

4. The image processing apparatus according to claim 3,
wherein the smallest value judgment means determines, as the optimum adjustment amount, the adjustment amount at which one of the sum and the variance of the differences between brightness values is smallest for each of the divided regions and the number of regions where one of the sum and the variance of the differences between brightness values is smallest is largest.

5. The image processing apparatus according to claim 4,
wherein the smallest value judgment means multiplies one of the sum and the variance of the differences between brightness values by a weighting factor in accordance with a degree of gaze in each region with respect to the divided regions and determines, as the optimum adjustment amount, the adjustment amount at which the number of regions is largest, in which one of the sum and the variance of the differences between brightness values after the multiplication is smallest.

6. The image processing apparatus according to claim 1,
wherein the smallest value judgment means includes
a number-of-pixels count means for counting, as the calculation amount using the difference between brightness values, the number of pixels having the difference between brightness values that is equal to or larger than the predetermined threshold value, and
an optimum adjustment amount determination means for determining, as the optimum adjustment amount, the adjustment amount at which the number of pixels having the difference between brightness values that is equal to or larger than the predetermined threshold value is smallest, out of the adjustment amounts of the parallax amounts plurally set by the parallax amount adjustment means.

7. The image processing apparatus according to claim 6, further comprising
a region division means for dividing the two-dimensional image for left eye and the two-dimensional image for right eye into a plurality of regions,
wherein the smallest value judgment means determines the optimum adjustment amount by judging the adjustment amount at which the number of pixels having the difference between brightness values that is equal to or larger than the predetermined threshold value is smallest for each of the divided regions.

8. The image processing apparatus according to claim 7,
wherein the smallest value judgment means determines, as the optimum adjustment amount, the adjustment amount at which the number of pixels having the difference between brightness values that is equal to or larger than the predetermined threshold value is smallest for each of the divided regions and the number of regions where the number of pixels having the difference between brightness values that is equal to or larger than the predetermined threshold value is smallest is largest.

9. The image processing apparatus according to claim 8,
wherein the smallest value judgment means multiplies the number of pixels having the difference between brightness values that is equal to or larger than the predetermined threshold value by a weighting factor in accordance with a degree of gaze in each region with respect to the divided regions and determines, as the optimum adjustment amount, the adjustment amount at which the number of regions is largest, in which the number of pixels having the difference between brightness values that is equal to or larger than the predetermined threshold value after the multiplication is smallest.

10. The image processing apparatus according to claim 1, further comprising
a conversion means for performing data format conversion between a data format of a first three-dimensional image including the two-dimensional image for left eye and the two-dimensional image for right eye and a data format of a second three-dimensional image, the data format of the second three-dimensional image being different from that of the first three-dimensional image.

11. The image processing apparatus according to claim 1, further comprising
a control means for changing the optimum adjustment amount determined by the smallest value judgment means in accordance with one of a specification of a display apparatus that displays the two-dimensional image for left eye and the two-dimensional image for right eye, and a specification of the two-dimensional image for left eye and the two-dimensional image for right eye as a three-dimensional image.

12. The image processing apparatus according to claim 1,
wherein the smallest value judgment means includes
a sum calculation means for calculating a sum of the differences between brightness values,
a first optimum adjustment amount determination means for determining, as the optimum adjustment amount, the adjustment amount at which one of the sum and a variance of the differences between brightness values is smallest, out of the parallax amounts plurally set by the parallax amount adjustment means,
a number-of-pixels count means for counting the number of pixels having the difference between brightness values that is equal to or larger than a predetermined threshold value, and
a second optimum adjustment amount determination means for determining, as the optimum adjustment amount, the adjustment amount at which the number of pixels having the difference between brightness values that is equal to or larger than the predetermined threshold value is smallest, out of the parallax amounts plurally set by the parallax amount adjustment means.

13. The image processing apparatus according to claim 12, further comprising
a control means for selecting one of the optimum adjustment amount determined by the first optimum adjustment amount determination means and the optimum adjustment amount determined by the second optimum adjustment amount determination means.

14. An image processing method, comprising:
setting an adjustment amount of a parallax amount with respect to a two-dimensional image for left eye and a two-dimensional image for right eye;
calculating a difference between brightness values of the two-dimensional image for left eye and the two-dimensional image for right eye in which the parallax amount is changed using the set adjustment amount;
determining an optimum adjustment amount by judging the adjustment amount at which a calculation amount using the difference between brightness values is smallest; and
adjusting the parallax amount of the two-dimensional image for left eye and the two-dimensional image for right eye, based on the determined optimum adjustment amount.

15. A program causing a computer to execute:
setting an adjustment amount of a parallax amount with respect to a two-dimensional image for left eye and a two-dimensional image for right eye;
calculating a difference between brightness values of the two-dimensional image for left eye and the two-dimensional image for right eye in which the parallax amount is changed using the set adjustment amount;
determining an optimum adjustment amount by judging the adjustment amount at which a calculation amount using the difference between brightness values is smallest; and
adjusting the parallax amount of the two-dimensional image for left eye and the two-dimensional image for right eye, based on the determined optimum adjustment amount.

16. A three-dimensional image display apparatus, comprising:
an adjustment amount setting means for setting an adjustment amount of a parallax amount with respect to a two-dimensional image for left eye and a two-dimensional image for right eye;
a difference calculation means for calculating a difference between brightness values of the two-dimensional image for left eye and the two-dimensional image for right eye in which the parallax amount is changed using the adjustment amount set by the adjustment amount setting means;
a smallest value judgment means for determining an optimum adjustment amount by judging the adjustment amount at which a calculation amount using the difference between brightness values is smallest;
a parallax amount adjustment means for adjusting the parallax amount of the two-dimensional image for left eye and the two-dimensional image for right eye, based on the optimum adjustment amount determined by the smallest value judgment means; and
a display means for displaying the two-dimensional image for left eye and the two-dimensional image for right eye in which the parallax amount is adjusted by the parallax amount adjustment means.

17. An image processing apparatus, comprising:
an adjustment amount setting section to set an adjustment amount of a parallax amount with respect to a two-dimensional image for left eye and a two-dimensional image for right eye;
a difference calculation section to calculate a difference between brightness values of the two-dimensional image for left eye and the two-dimensional image for right eye in which the parallax amount is changed using the adjustment amount set by the adjustment amount setting section;
a smallest value judgment section to determine an optimum adjustment amount by judging the adjustment amount at which a calculation amount using the difference between brightness values is smallest; and
a parallax amount adjustment section to adjust the parallax amount of the two-dimensional image for left eye and the two-dimensional image for right eye, based on the optimum adjustment amount determined by the smallest value judgment section.

18. A three-dimensional image display apparatus, comprising:
an adjustment amount setting section to set an adjustment amount of a parallax amount with respect to a two-dimensional image for left eye and a two-dimensional image for right eye;
a difference calculation section to calculate a difference between brightness values of the two-dimensional image for left eye and the two-dimensional image for right eye in which the parallax amount is changed using the adjustment amount set by the adjustment amount setting section;
a smallest value judgment section to determine an optimum adjustment amount by judging the adjustment amount at which a calculation amount using the difference between brightness values is smallest;
a parallax amount adjustment section to adjust the parallax amount of the two-dimensional image for left eye and the two-dimensional image for right eye, based on the optimum adjustment amount determined by the smallest value judgment section; and
a display section to display the two-dimensional image for left eye and the two-dimensional image for right eye in which the parallax amount is adjusted by the parallax amount adjustment section.
